(19) United States
(12) Patent Application Publication
(10) Pub. No.: US 2025/0075813 A1
(43) Pub. Date: Mar. 6, 2025

(54) CHECK VALVES

(71) Applicant: Scope Technology and Manufacturing, LLC, Houston, TX (US)

(72) Inventors: Michael James Cornelssen, Spring, TX (US); Christopher Mark Koch, Covington, TX (US); Tony Cordova, Humble, TX (US)

(21) Appl. No.: 18/818,269

(22) Filed: Aug. 28, 2024

Related U.S. Application Data
(60) Provisional application No. 63/579,180, filed on Aug. 28, 2023.

(51) Int. Cl. F16K 15/03; F16K 27/02

(52) U.S. Cl. CPC F16K 15/034; F16K 27/0227

(57) ABSTRACT

A check valve includes a housing having an upstream end and a downstream end. The housing includes a throughbore extending from the upstream end to the downstream end, an outer surface extending from the upstream end to the downstream end, and an access port extending from the outer surface to the throughbore. The access port includes an internal annular shoulder and one or more recesses extending into the internal annular shoulder. In addition, the check valve includes a valve seat disposed in the throughbore of the housing. Further, the check valve includes a check valve assembly at least partially disposed in the access port. The check valve assembly includes a flapper extending into the throughbore and configured to pivot relative to the valve seat between an open position spaced apart from the valve seat and a closed position engaging the valve seat. The check valve assembly also includes one or more flapper alignment members pivotally coupled to the flapper, wherein each flapper alignment member is slidingly seated in one of the recesses in the internal annular shoulder of the access port to align the flapper with the valve seat in the throughbore.

### CROSS-REFERENCE TO RELATED APPLICATIONS

This application claims benefit of U.S. provisional patent application Ser. No. 63/579,180 filed Aug. 28, 2023, and entitled “Check Valves,” which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure generally relates to check valves and methods related thereto. For instance, this disclosure relates to check valves that are configured to provide enhanced functionality and performance.

A check valve is a fluid flow control device that may generally allow fluid flow in one direction along a fluid flow line (e.g., pipe, hose, conduit, etc.). Check valves are utilized in a variety of different applications (including industrial applications) such as chemical processing plants, refineries, water treatment facilities, to name a few. Check valves serve an important role by preventing undesirable flow, such as backflow within a fluid flow line. Thus, the reliability, functionality, and design of a check valve may be a central consideration for ensuring reliable and safe operation of the corresponding process or system.

### BRIEF SUMMARY

Embodiments of check valves are disclosed herein. In one embodiment, a check valve comprises a housing having an upstream end and a downstream end. The housing comprises a throughbore extending from the upstream end to the downstream end, an outer surface extending from the upstream end to the downstream end, and an access port extending from the outer surface to the throughbore. The access port comprises an internal annular shoulder and one or more recesses extending into the internal annular shoulder. In addition, the check valve comprises a valve seat disposed in the throughbore of the housing. Further, the check valve comprises a check valve assembly at least partially disposed in the access port. The check valve assembly comprises a flapper extending into the throughbore and configured to pivot relative to the valve seat between an open position spaced apart from the valve seat and a closed position engaging the valve seat. The check valve assembly also comprises one or more flapper alignment members pivotally coupled to the flapper, wherein each flapper alignment member is slidingly seated in one of the recesses in the internal annular shoulder of the access port to align the flapper with the valve seat in the throughbore.

Embodiments of methods of assembly a check valve are disclosed herein. In one embodiment, a method of assembling a check valve comprises (a) inserting a check valve assembly in an access port of a housing of the check valve. The access port has an internal annular shoulder including one or more recesses formed therein. The check valve assembly includes a flapper and one or more flapper alignment members pivotally coupled to the flapper. The method also comprises (b) rotating the check valve assembly about a central axis of the access port during or after (a) to insert the one or more flapper alignment members into the one or more recesses and align the flapper relative to a valve seat positioned in a throughbore of the housing.

In another embodiment, a check valve comprises a housing. The housing includes a throughbore having a valve seat therein, an outer surface, and an access bore extending from the outer surface to the throughbore. The access bore has an internal annular shoulder including one or more recesses defined therein. In addition, the check valve comprises a check valve assembly at least partially inserted into the access bore. The check valve assembly includes an alignment ring and a flapper pivotably coupled to the alignment ring. The alignment ring includes an outer annular shoulder having one or more keys extending therefrom. The one or more keys are received into the one or more recesses to align the flapper with the valve seat in the throughbore.

In another embodiment, a method of assembling a check valve comprises (a) inserting an alignment ring into an access bore of a housing of the check valve. The access bore has an internal annular shoulder further including one or more recesses formed therein. In addition, the method comprises (b) rotating the alignment ring during (a) to insert one or more keys formed on an outer annular shoulder of the alignment ring axially into the one or more recesses along a central axis of the access bore, thereby to align a flapper pivotably coupled to the alignment ring with a valve seat positioned in the housing.

In yet another embodiment, a check valve comprises a housing. The housing includes a throughbore having a valve seat therein, an outer surface, and an access bore extending from the outer surface to the throughbore. In addition, the check valve comprises a check valve assembly at least partially inserted into the access bore. The check valve assembly includes an alignment ring and a flapper including a first side and a second side. The flapper is pivotably coupled to the alignment ring to engage the first side with the valve seat. The check valve also comprises a weight removably coupled to and positioned on the second side of the flapper.

In still yet another embodiment, a check valve comprises a housing. In addition, the check valve comprises a check valve assembly configured to be at least partially inserted into the housing. The check valve assembly includes an alignment ring including a hinge block having a receptacle. The receptacle has an inner annular shoulder. The check valve assembly also includes a bushing having a flange that defines an outer annular shoulder. The bushing is configured to be inserted into the receptacle so that the outer annular shoulder abuts the inner annular shoulder. Further, the check valve assembly includes a flapper including a hinge ear having an aperture. Moreover, the check valve assembly includes a pin configured to extend through the aperture of the hinge ear and into the bushing within the receptacle to pivotably couple the flapper to the alignment ring.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various embodiments, reference will now be made to the accompanying drawings in which:

FIG. 1 is a schematic diagram of an embodiment of a hydraulic fracturing system in accordance with the principles described herein;

FIG. 2 is a perspective view of an embodiment of a check valve in accordance with the principles described herein that may be used in the hydraulic fracturing system of FIG. 1;

FIG. 3 is a side, cross-sectional view of the check valve of FIG. 2 taken along section 3-3 of FIG. 2;

FIG. 4 is a perspective, cross-sectional view of the check valve of FIG. 2 also taken along section 3-3 in FIG. 2;

FIG. 5 is an exploded view of the check valve of FIG. 2;

FIG. 6 is an enlarged cross-sectional view of the access port of the housing of the check valve of FIG. 2;

FIG. 7 is an enlarged, perspective cross-sectional view of the access port of FIG. 6;

FIG. 8 is a perspective view of the valve seat of the check valve of FIG. 2;

FIG. 9 is an exploded view of the flapper of the check valve of FIG. 2 according to some embodiments disclosed herein;

FIG. 10 is a perspective view of the alignment ring of the check valve of FIG. 2;

FIG. 11 is a side view of the alignment ring of FIG. 10;

FIG. 12 is a bottom view of the alignment ring of FIG. 10;

FIG. 13 is a perspective view of the flapper of FIG. 8 and the alignment ring of FIGS. 10-12 assembled together;

FIG. 14 is an enlarged cross-sectional view of the flapper and the alignment ring of FIG. 13 taken along section 14-14 in FIG. 13;

FIG. 15 is a side cross-sectional view of the plug of the check valve of FIG. 2;

FIG. 16 is a side cross-sectional view of the bonnet of the check valve of FIG. 2;

FIGS. 17-19 are sequential, perspective views depicting the assembly of the check valve of FIG. 2 in accordance with the principles disclosed herein;

FIG. 20 is a is a side, cross-sectional view of the check valve of FIG. 2 taken along section 3-3 in FIG. 2 illustrating the check valve in an open position;

FIG. 21 is a perspective view of an embodiment of a check valve in accordance with the principles described herein that may be used in the hydraulic fracturing system of FIG. 1;

FIG. 22 is a side, cross-sectional view of the check valve of FIG. 21 taken along section 22-22 in FIG. 21;

FIG. 23 is a perspective, cross-sectional view of the check valve of FIG. 2 also taken along section 22-22 in FIG. 21;

FIG. 24 is an exploded view of the check valve of FIG. 21;

FIG. 25 is an enlarged cross-sectional view of the access port of the housing of the check valve of FIG. 21;

FIG. 26 is a perspective view of the flapper and the hinge blocks of the check valve of FIG. 21 assembled together;

FIG. 27 is an enlarged cross-sectional view of the hinge ears of the flapper and the hinge blocks of FIG. 26 taken along section 27-27 in FIG. 26;

FIG. 28 is a side cross-sectional view of the plug of the check valve of FIG. 21;

FIG. 29 is a side cross-sectional view of the bonnet of the check valve of FIG. 21;

FIGS. 30-32 are sequential, perspective views depicting the assembly of the check valve of FIG. 21 in accordance with principles described herein; and

FIG. 33 is an end, cross-sectional view of the check valve of FIG. 21 taken along section 33-33 in FIG. 21 showing an embodiment of a tool for installing and removing the plug and the bonnet of the check valve of FIG. 21.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . . ” Use of the term “optionally” with respect to any element of a claim is intended to mean that the subject element is required, or alternatively, is not required. Both alternatives are intended to be within the scope of the claim.

The term “couple” or “couples” is intended to mean either an indirect or direct connection. Thus, if a first device couples to a second device, that connection may be through a direct engagement between the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88degrees.

As previously described, a check valve may ensure proper fluid flow direction in a variety of applications, including numerous industrial applications. In one particular example, a check valve may be utilized in or with a system for performing a hydraulic fracturing operation for a subterranean wellbore.

Generally speaking, during a hydraulic fracturing operation a pressurized fracturing fluid is injected into a subterranean formation via a wellbore or multiple wellbores. The injected fracturing fluid is at a higher pressure than the fracture pressure of the subterranean formation such that the fluid creates fractures therein. The fractures increase a permeability of the subterranean formation so that formation fluids (such as oil, gas, water, etc.) may more easily escape the subterranean formation and flow to the surface via the wellbore(s). Proppant (such as sand or other solids) may be mixed with the fracturing fluid prior to injecting the fracturing fluid downhole. The proppant may flow into the fractures in the subterranean formation to hold the fractures open after the hydraulic fracturing operation has ended.

Various fluid conveyance devices and systems are positioned at the surface to route the fracturing fluids into and out of the wellbore(s) during the hydraulic fracturing operation. The fluid conveyance devices may include various combinations of pipes, hoses, conduits, manifolds, tanks, pumps, etc. At least some of these devices transport the fracturing fluid after it has been pressurized into the wellbore(s). Given the high injection pressures involved, backflow of fluid (e.g., fracturing fluid, formation fluid, etc.) from the wellbore is a concern during a hydraulic fracturing operations. As a result, one or more check valves may be placed in fluid communication between the subterranean wellbore and the fluid conveyance devices at the surface to allow fluid flow toward the wellbore and to prevent and/or restrict backflow therefrom. However, a check valve utilized in a severe service such as hydraulic fracturing may suffer a number of failures and a somewhat reduced service life. Thus, operators of a hydraulic fracturing operation would benefit from check valve designs that provide, among other things, an increased service life, that facilitate proper installation, and that allow for in-field customization to ensure optimal performance. Accordingly, embodiments disclosed herein include check valves and related assemblies that may provide an enhanced functionality and performance when compared with conventional designs. In some embodiments, a check valve may include one or more features that reduce wear so as to effectively increase a service life of the check valve or components thereof. In addition, in some embodiments, a check valve may include one or more features that facilitate proper installation, maintenance, and customization in the field by on-site technicians so that failures and stoppages due to improper check valve installation or configuration may be reduced or even entirely prevented. Thus, through use of the embodiments disclosed herein, a check valve may enjoy an improved reliability and functionality.

While various specific embodiments of check valves are described herein in relation to use within a hydraulic fracturing system, it should be appreciated that embodiments of the check valves described herein may be used in a number of other applications, including industrial or consumer applications, separate from hydraulic fracturing. Thus, the particular references to a hydraulic fracturing system are merely intended to describe some potential applications and are not intended to limit other potential uses or applications of embodiments of the check valves described herein.

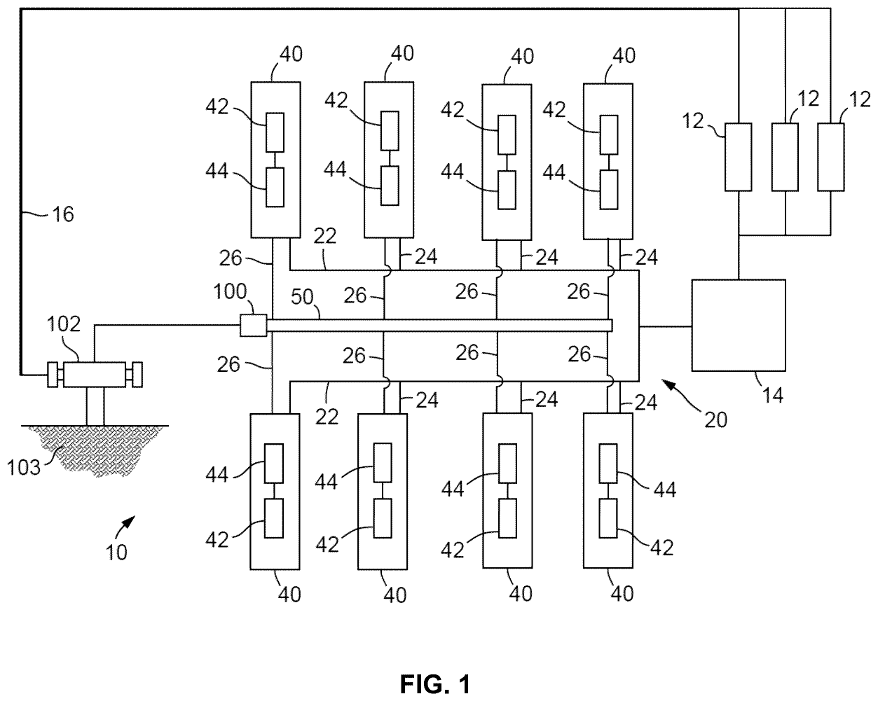

FIG. 1 illustrates a schematic diagram of a hydraulic fracturing system 10 including a check valve 100 according to some embodiments. During operations, system 10 may inject a high-pressure fracturing fluid into a wellhead 102 that is connected to a wellbore (not shown) extending into a subterranean formation 103 to fracture subterranean formation 103 as previously described. In some embodiments, system 10 may inject the high-pressure fracturing fluid into a plurality of wellheads (e.g., wellhead 102) so as to access subterranean formation 103 via a plurality of wellbores.

It should be appreciated that the hydraulic fracturing system 10 shown in FIG. 1 depicts some components and assemblies that may be used during a hydraulic fracturing operation, and that additional or fewer components may be used for other embodiments of system 10. Thus, the particular combination and/or arrangement of components of system 10 depicted in FIG. 1 is not limiting to other potential embodiments of system 10.

System 10 generally includes a plurality of storage vessels 12 that are each configured to hold a volume of fracturing fluid therein. The fracturing fluid stored in storage vessels 12 may include any liquid or semi-liquid (such as a gel) that is suitable for injection into and fracturing of subterranean formation 103 as previously described. In some embodiments, the fracturing fluid includes an aqueous solution including substantially pure water or water mixed with one or more additives (such as gels, gelling agents, chemicals, etc.). Storage vessels 12 may include any suitable container for holding a volume of fluids (such as liquids) therein. For instance, in some embodiments, storage vessels may include rigid tanks, flexible tanks (such as bladders), open pits, mobile tanks (that may be pulled by a tractor trailer or other vehicle), or a combination thereof.

As shown in FIG. 1, a blender 14 is positioned downstream of storage vessels 12 that is configured to mix a proppant into the fracturing fluid. The proppant may include sand or other suitable solids. As previously described, the proppant is configured to flow into the fractures within subterranean formation 103 so as to hold the fractures open after the hydraulic fracturing operation has ended. In some embodiments, additives (such as chemical additives) may be mixed into the fracturing fluid within the blender 14 either in addition or alternatively to the proppant. The blender 14 emits the fracturing fluid, now with proppant mixed therein, to a manifold assembly 20 that communicates the fracturing fluid to and from a plurality of pumping units 40.

Specifically, manifold assembly 20 includes one or more low-pressure, inlet manifolds 22 and one or more high-pressure, outlet manifolds 50. In the particular embodiment depicted in FIG. 1, manifold assembly 20 includes two inlet manifolds 22 and a single outlet manifold 50. However, in other embodiments, different members, arrangements, and combinations of inlet manifolds 22 and outlet manifolds 50 may be utilized, such as, for instance, a single outlet manifold 50, a plurality of outlet manifolds 50, a single inlet manifold 22, or a plurality of inlet manifolds 22. A plurality of inlet conduits 24 connect the inlet manifolds 22 to the plurality of pumping units 40. In addition, a plurality of outlet conduits 26 connect the plurality of pumping units 40 to outlet manifold 50.

Each pumping unit 40 includes a pump 44 driven by a driver 42 (which may be referred to herein as a “prime mover”). Pump 44 may include any suitable fluid pumping device or assembly for pressurizing the fracturing fluid (with or without proppant and/or other additives entrained therein) to the pressures associated with a hydraulic fracturing operation. For instance, in some embodiments, pump 44 may be configured to pressurize the fracturing fluid (again, with or without proppant and/or other additives entrained therein) to a pressure of about 9,000 pounds per square inch (psi) or higher. Thus, pump 44 may be referred to herein as a “hydraulic fracturing pump” 44. In some embodiments, pump 44 may include a positive displacement pump, centrifugal pump, or other suitable pump types. Driver 42 may include any suitable motor or engine that is configured to drive or actuate the corresponding pump 44 during operations. For instance, in some embodiments, driver 42 may include a diesel engine, a turbine (such as a gas turbine, steam turbine, etc.), an electric motor, or some combination thereof. During operations, within each pumping unit 40, driver 42 may actuate pump 44 to drawn fracturing fluid into pump 44 via the corresponding inlet conduit 24 and to pressurize and output the fracturing fluid from pump 44 via the corresponding outlet conduit 26.

During operations, pressurized fracturing fluid is received by outlet manifold 50 via outlet conduits 26. Outlet manifold 50 then directs the pressurized fracturing fluid toward wellhead 102 such that it may access subterranean formation 103 as previously described. During the hydraulic fracturing operations, fracturing fluid may be emitted from the wellbore via wellhead 102 and recycled back to storage vessels 12 through one or more return or recycle conduits 16. In some embodiments, the fracturing fluid output from wellhead 102 may be routed through one or more filtering or separation assemblies or devices (not shown) to remove additives, proppant, and/or other fluids or solids (such as rock chips, formation fluids, etc.) that may be entrained within the fracturing fluid, prior to recycling the fracturing fluid to storage vessels 12.

Check valve 100 is in fluid communication between manifold 50 and wellhead 102. For instance, in some embodiments, check valve 100 may be connected or even integrated into a downstream end of outlet manifold 50 (however, other locations are contemplated). Generally speaking, during the above-described hydraulic fracturing operations, check valve 100 may facilitate or allow flow from outlet manifold 50 to wellhead 102 but prevents (or at least restrict) backflow of fluid from wellhead 102 to outlet manifold 50 during a hydraulic fracturing operation. Thus, check valve 100 may prevent backflow of fluid from wellhead 102 to the pumping units 44 (which may cause damage thereto).

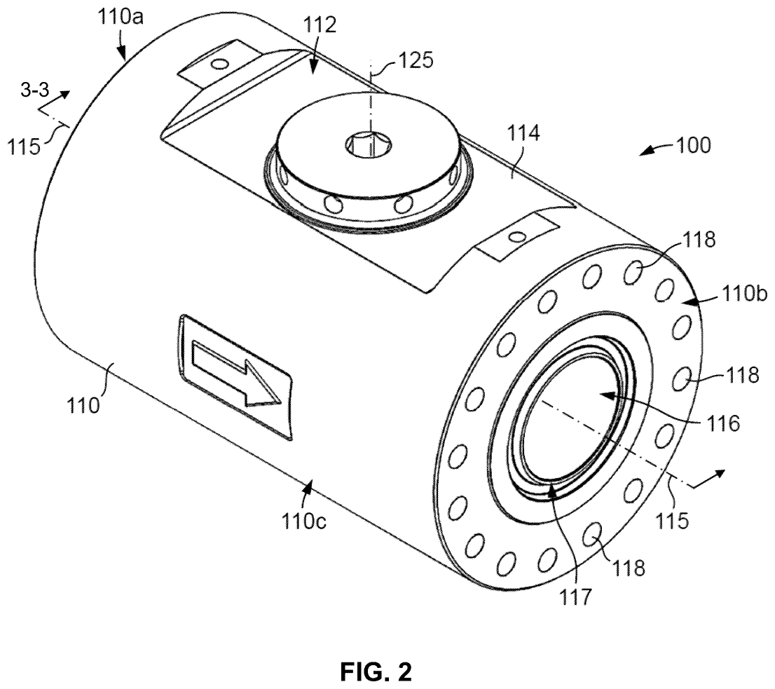

Referring now to FIGS. 2-5, check valve 100 for use with the hydraulic fracturing system 10 of FIG. 1 is shown according to some embodiments. Check valve 100 includes a body or housing 110 and a check valve assembly 150 (or more simply “valve assembly” 150) at least partially positioned in housing 110.

Housing 110 is a generally elongate cylindrical body that includes a central or longitudinal axis 115, a first or upstream end 110a, and a second or downstream end 110b axially opposite upstream end 110a (relative to axis 115). In addition, housing 110 includes a radially outer surface 110c extending axially between ends 110a, 110b. In the illustrated embodiment, radially outer surface 110c is a generally cylindrical surface; however, other shapes or curvatures are contemplated herein (such as square, rectangular, or polygonal cross-sections). A throughbore 116 also extends axially (relative to axis 115) through housing 110 from upstream end 110a to downstream end 110b so as to define an inlet 113 at upstream end 110a and an outlet 117 at downstream end 110b.

A radial recess 112 is defined along radially outer surface 110c and extends radially inward toward axis 115. Recess 112 is defined by an axially extending planar surface 114 oriented parallel to axis 115. An access port 120 extends radially (relative to axis 115) from planar surface 114 to throughbore 116. In particular, access port 120 extends along a central or longitudinal axis 125 that may be orthogonal or perpendicular to axis 115 so that axes 115, 125 lie within and/or define a plane (not shown). Access port 120 is axially positioned between ends 110a, 110b, and in this embodiment, is positioned substantially equidistant between ends 110a, 110b.

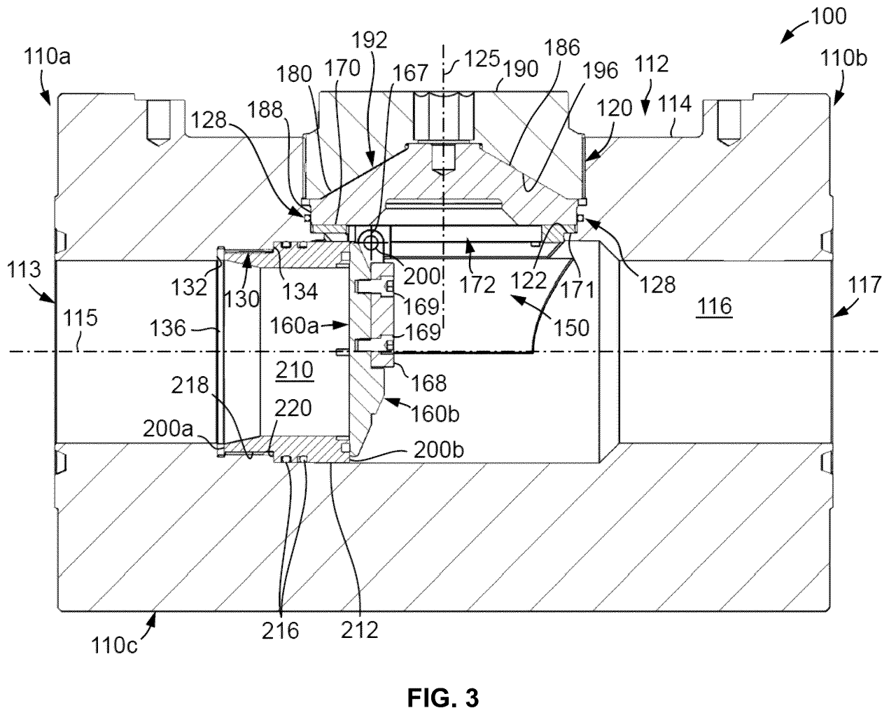

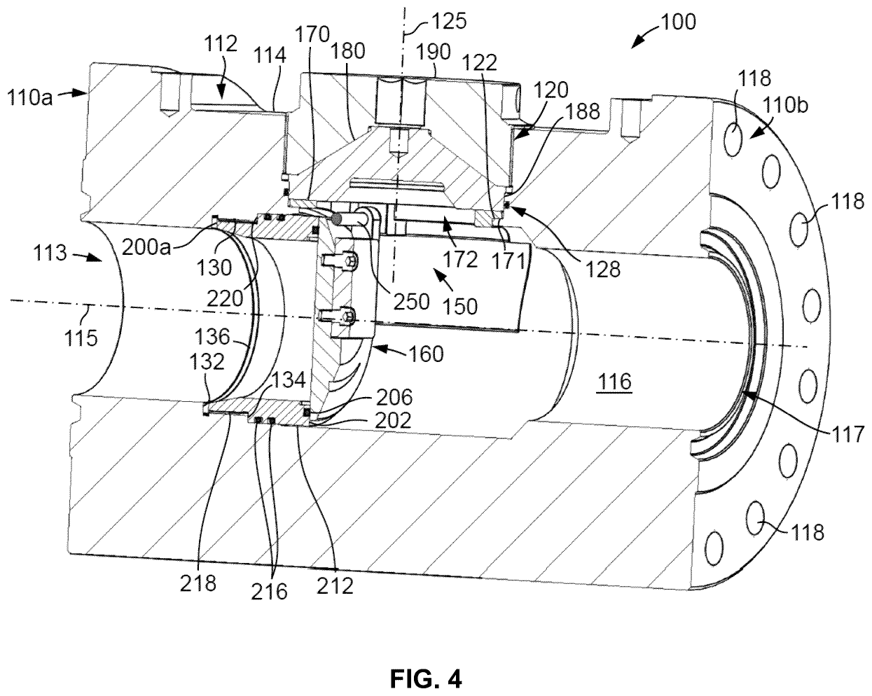

As shown in FIGS. 3 and 4, a pair of axially spaced, internal, radially inwardly extending annular shoulders 132, 134 are provided along throughbore 116 and axially positioned (relative to axis 115) between access port 120 and upstream end 110a. In this embodiment, both shoulders 132, 134 are defined by annular planar surfaces disposed in planes oriented perpendicular to axis 115 and facing axially toward downstream end 110b. The pair of annular shoulders 132, 134 includes a first or upstream shoulder 132 and a second or downstream shoulder 134 axially positioned (relative to axis 115) between upstream shoulder 132 and access port 120. The inner diameter of throughbore 116 may be greater at downstream shoulder 134 than at upstream shoulder 132 so that downstream shoulder 134 may be at least partially positioned radially outside or beyond upstream shoulder 132 (relative to axis 115). In addition, a set of internal threads 130 is provided along throughbore 116 and is axially positioned between upstream shoulder 132 and downstream shoulder 134.

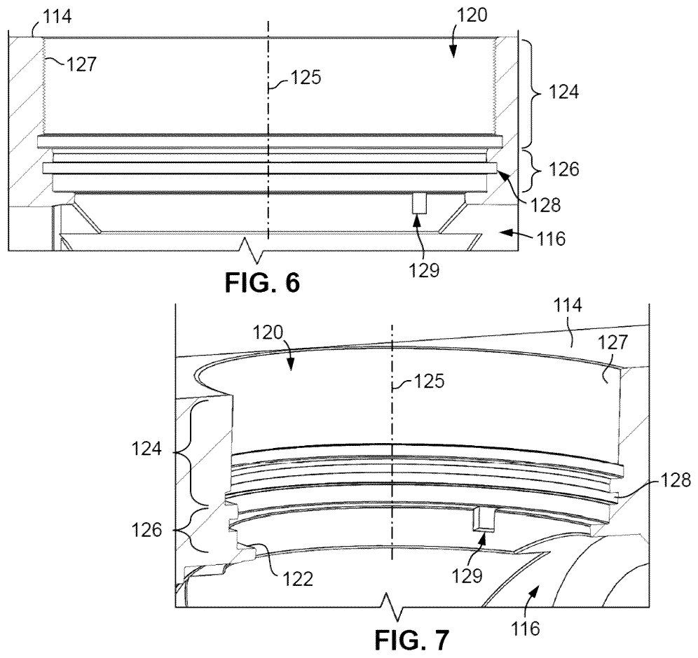

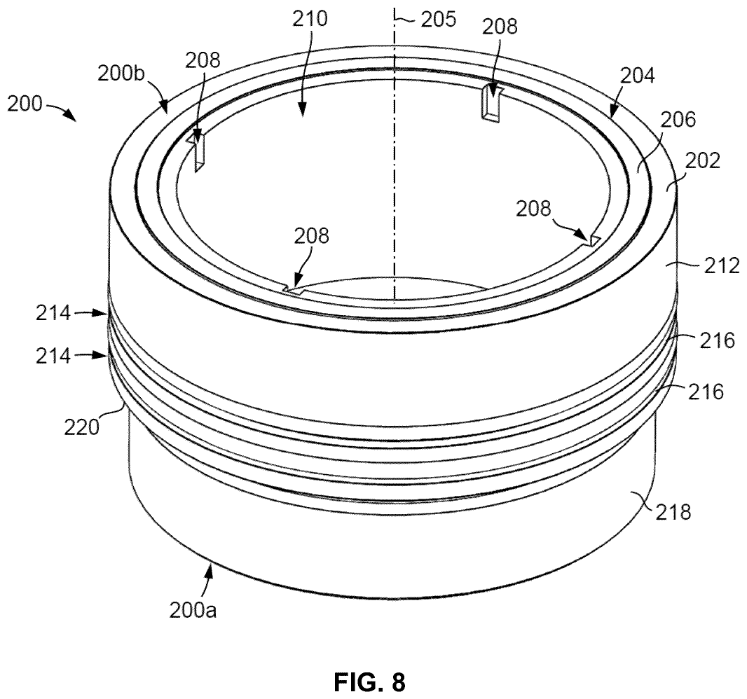

FIGS. 6 and 7 show access port 120 in more detail according to some embodiments. As shown, access port 120 includes a first or radially outer portion 124 (relative to axis 115) that extends axially along the axis 125 from planar surface 114 and includes one or more internal threads 127. In addition, access port 120 includes an internal annular shoulder 122 that extends radially inward toward the axis 125 that is axially spaced (relative to axis 125) from first portion 124. In this embodiment, annular shoulder 122 is defined by an annular planar surface disposed in a plane oriented perpendicular to axis 125 and facing axially (relative to axis 125) toward planar surface 114. As will be described in more detail below, annular shoulder 122 may include on or more (e.g., such as a plurality of) circumferentially-spaced, axially extending recesses or slots 129 defined therein. Still further, access port 120 may include a second or radially inner portion 126 (relative to axis 115) that extends between first portion 124 and annular shoulder 122. Second portion 126 may include one or more seal grooves 128 defined therein that receive suitable annular sealing members (e.g., O-rings) during operations as described in more detail herein.

Referring again to FIGS. 2-5, check valve assembly 150 also includes a flapper (or valve element) 160 pivotably coupled to an alignment ring 170 via a pin 250 (FIG. 4). Alignment ring 170 may also be referred to herein as a “HALO” ring. In addition, check valve assembly 150 includes a plug 180, a bonnet 190, and a valve seat 200. Each of these components is described in more detail below.

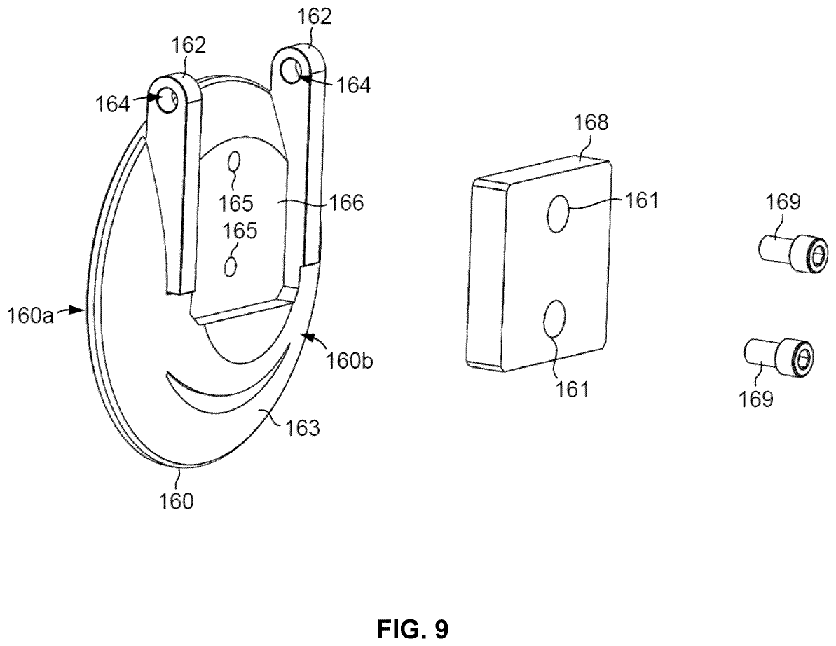

Referring now to FIG. 8, valve seat 200 is a generally cylindrical member that includes a central or longitudinal axis 205, a first or upstream end 200a, and a second or downstream end 200b axially spaced (relative to axis 205) from upstream end 200a. A throughbore 210 extends axially (relative to axis 205) from upstream end 200a to downstream end 200b. In addition, valve seat 200 includes a first or upstream cylindrical portion 218 extending axially from the first end 200a and a second or downstream cylindrical portion 212 extending axially from downstream end 200b. The downstream cylindrical portion 212 has a greater outer diameter than upstream portion 218 such that that an outer radially extending annular shoulder 220 is provided axially (relative to axis 205) between portions 212, 218. In this embodiment, annular shoulder 220 is disposed in a plane oriented perpendicular to axis 205 and faces axially toward first end 200a. Upstream portion 218 includes one or more external threads (not specifically shown) disposed thereon.

Downstream end 200b includes a strike face 202 that may comprise a planar, annular surface that extends radially relative to central axis 205 (although, other shapes or configurations are contemplated, such as a frustoconical surface). An annular groove 204 extends axially (relative to axis 205) into strike face 202 and extends circumferentially about axis 205. An annular seal member 206 is seated in mating groove 204 and selectively engages with flapper 160 during operations to prevent fluid flow between flapper 160 and strike face 202 along throughbore 116 (FIG. 2). Annular seal member 206 may comprise any suitable material such as, for instance, a carbonaceous material, elastomeric material, metallic material, etc. For instance, in some embodiments, the seal member 206 may comprise an elastomeric face seal.

Valve seat 200 also includes a plurality of circumferential-spaced recesses 208 disposed along the inner surface of valve seat 200 defining throughbore 210 and extending axially from strike face 202. Recesses 208 may each be generally rectangularly shaped (e.g., such as a rectangular parallelepiped); however, other shapes (e.g., elliptical, circular, triangular, polygonal, etc.) are contemplated. Recesses 208 may be uniformly circumferentially-spaced about axis 205. For example, in the illustrated embodiment, a total of four (4) recesses 208 are uniformly circumferentially-spaced about 90° apart about axis 205. As will be described in more detail below, recesses 208 may receive projections on a suitable tool, such as a spanner wrench or socket to threadably engage valve seat 200 in throughbore 116 of housing 110 (FIG. 2).

A pair of axially spaced (relative to axis 205) annular seal grooves 214 are disposed along the radially outer surface of valve seat 200 along the downstream portion 212. Each of the annular seal grooves 214 receives an annular seal member 216 (e.g., an O-ring or other annular seal member) therein.

Referring again to FIGS. 3-5, valve seat 200 is threadably secured within throughbore 116 with axis 205 oriented parallel to and coaxially aligned with axis 115. Specifically, valve seat 200 is inserted axially (relative to axes 115, 205) into throughbore 116 via outlet 117 at downstream end 110b. Thereafter, the external threads on upstream portion 218 are threadably engaged with mating internal threads 130 along throughbore 116 until annular shoulder 220 engages and axially compresses against downstream shoulder 134. In addition, a gasket 136 (which may comprise a junk ring) may be compressed axially (relative to axis 115) between upstream shoulder 132 and upstream end 200a of valve seat 200 to prevent and/or restrict fluid from flowing between valve seat 200 and throughbore 116. Further, the pair of annular seal members 216 sealingly engage with the radially inner surface of housing 110 defining throughbore 116 to further prevent and/or restrict fluid flow between valve seat 200 and housing 110 during operations. In some embodiments, valve seat 200 may be removably secured in throughbore 116 via a non-threaded connection, such as for instance, a keyed connection, slotted connection, etc.

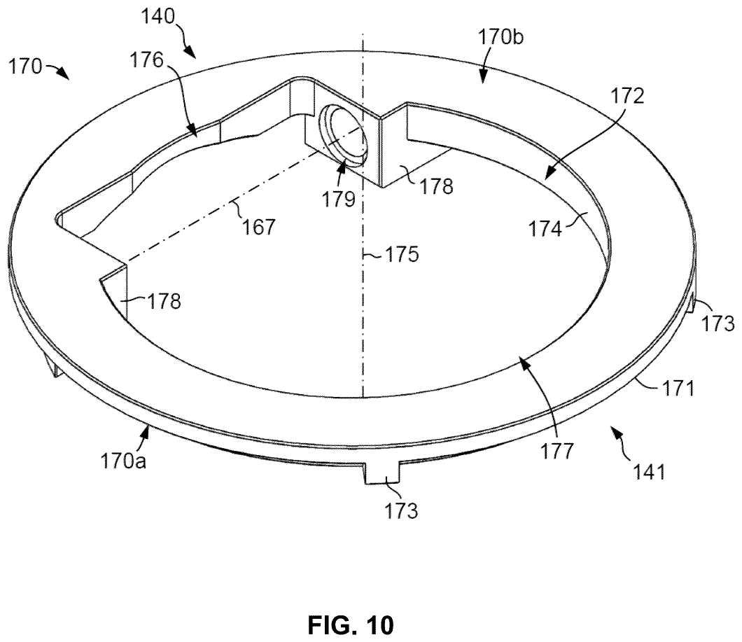

Referring now to FIG. 9, flapper 160 is a disc-shaped member having a first or front side 160a, and a second or back side 160b opposite front side 160a. Front side 160a may comprise a planar surface configured to mate and engage with valve seat 200 (particularly strike face 202 and annular seal member 206) during operations to prevent and/or restrict flow along throughbore 116 (FIG. 2). Back side 160b may include a generally convexly (bowed outwardly) curved surface 163 that may have any suitable curvature geometry (e.g., spherical, ellipsoid, etc.).

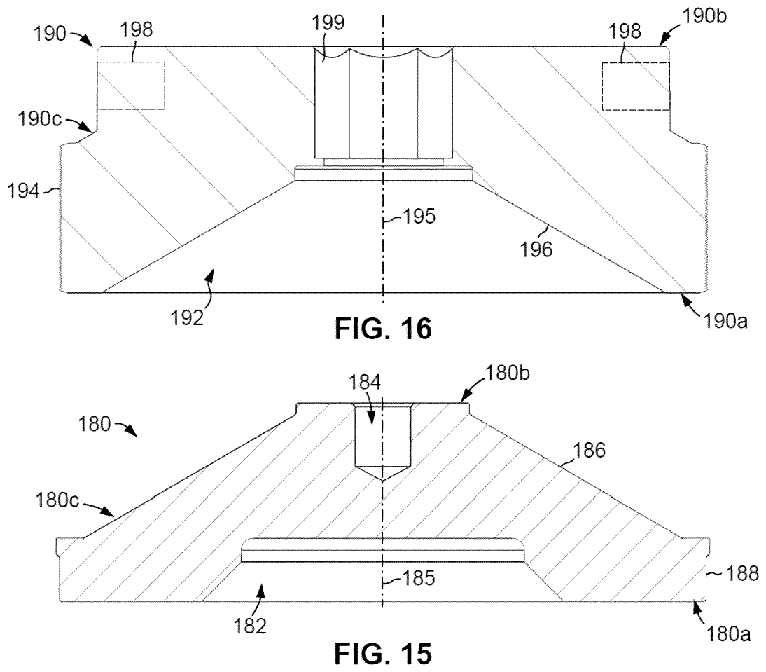

A pair of hinge ears 162 extend outwardly from back side 160b. Hinge ears 162 may be integrally formed with flapper 160 such as shown in FIG. 9, or may be separately formed and subsequently attached (e.g., via screws, bolts, rivets, welding, etc.) to flapper 160. Each hinge ear 162 includes an aperture 164 extending therethrough. Hinge ears 162 are arranged and positioned on flapper 160 such that apertures 164 are spaced apart and aligned along a common axis (not shown in FIG. 9, but see axis 167 in FIG. 13 and described herein).

A planar mounting surface 166 is defined on back side 160b of flapper 160, and includes one or more (e.g., a plurality of) mounting apertures 165. A separate weighting member 168 (or more simply “weight”) is seated against the mounting surface 166 and coupled to flapper 160 via one or more (e.g., a plurality of) mounting members 169 extend through weight 168 and into mounting apertures 165. In some embodiments, mounting members 169 may be readily removable (e.g., via the use of a suitable tool) to allow weight 168 to be removed and replaced with relative ease. For instance, in some embodiments, mounting members 169 may comprise externally threaded mounting members, such as screws, bolts, etc. and mounting apertures 165 may comprise internally threaded apertures. Weight 168 may have any suitable shape, such as for instance a rectangular shape as shown in FIG. 9 (e.g., a rectangular parallelepiped).

Without being limited to this or any other theory, weight 168 may be selected to provide a desired resistance to movement of flapper 160 within throughbore 116 during operations. Specifically, a weight 168 may be selected and replaced on back side 160b of flapper 160 so that the total weight of flapper 160 is adjusted based on the expected operating pressures and/or flow rates within throughbore 116 during operations. If a total weight of flapper 160 is too low relative to the expected operating pressures, then flapper 160 may violently slam into other components of the check valve when opening (e.g., alignment ring 170, plug 180, bonnet 190) and potentially cause damage thereto. On the other hand, if flapper 160 is too heavy relative to the expected operating pressures, then valve 100 may not fully open or may not maintain an open position during operations so that flapper 160 may “flutter” in throughbore 116, thereby increasing a rate of wear for one or more components of check valve 100 as described in more detail herein (e.g., pin 250, T-bushings 260, etc.).

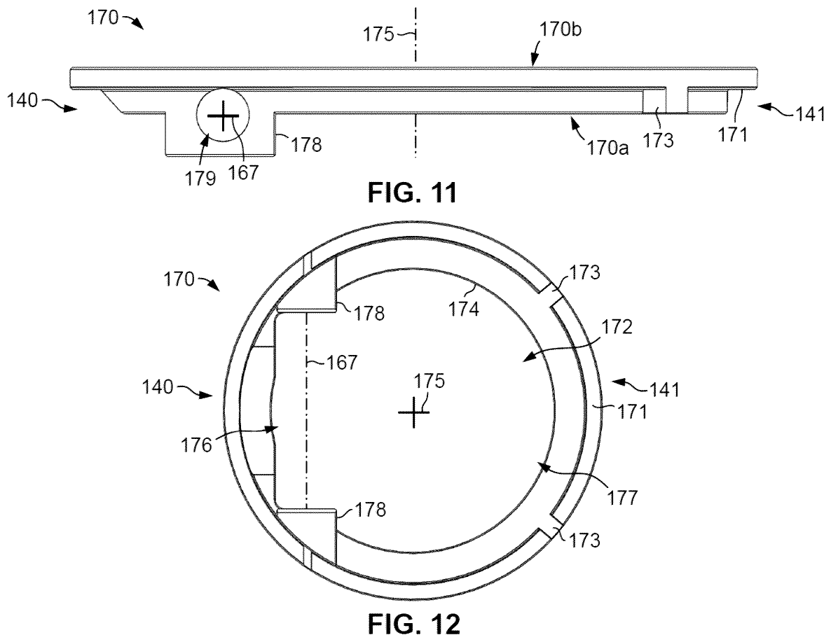

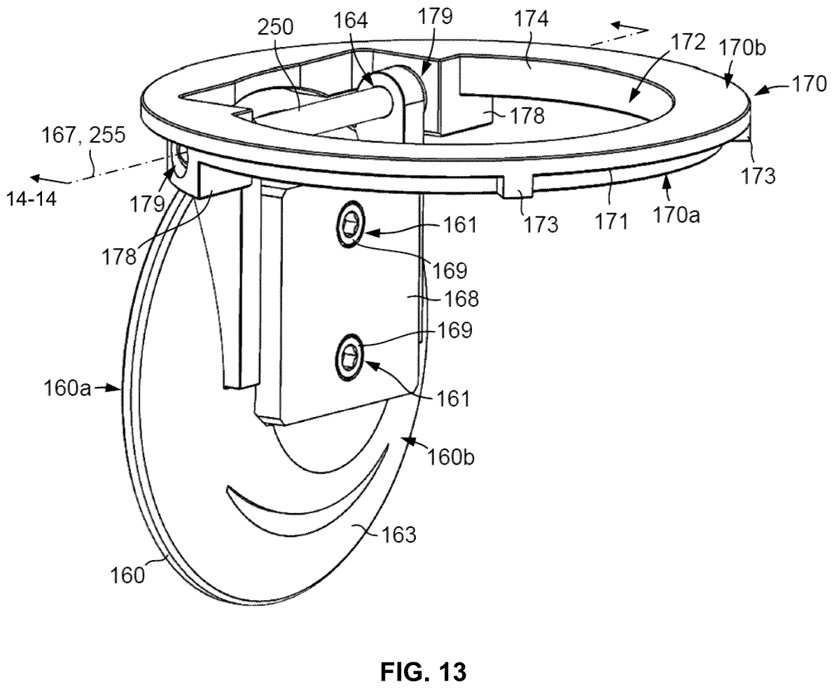

Referring now to FIGS. 10-12, alignment ring 170 has a central axis 175, a first or inner side 170a, and a second or outer side 170b axially opposite (relative to central axis 175) inner side 170a. In addition, alignment ring 170 includes a radially outer surface 170c extending axially (relative to central axis 175) from inner side 170a and outer side 170b, and a central aperture 172 extending axially (relative to central axis 175) from inner side 170a to outer side 170b.

Central aperture 172 includes a first or cylindrical portion 177 and a second or rectangular portion 176. Cylindrical portion 177 is generally defined by a cylindrical wall 174 that extends axially (relative to central axis 175) from inner side 170a to outer side 170b and extends circumferentially about central axis 175. Rectangular portion 176 extends radially (relative to central axis 175) from cylindrical portion 177 and has a rectangular shape when viewed in an axial direction along axis 175. A pair of hinge blocks 178 are positioned along inner side 170a of alignment ring 170 and partially define rectangular portion 176. Each hinge block 178 includes a receptacle 179. Receptacles 179 are aligned along a common axis 167 that is spaced from axis 175 and disposed in a plane oriented perpendicular to axis 175. In this embodiment, hinge blocks 178 are integral with alignment ring 170.

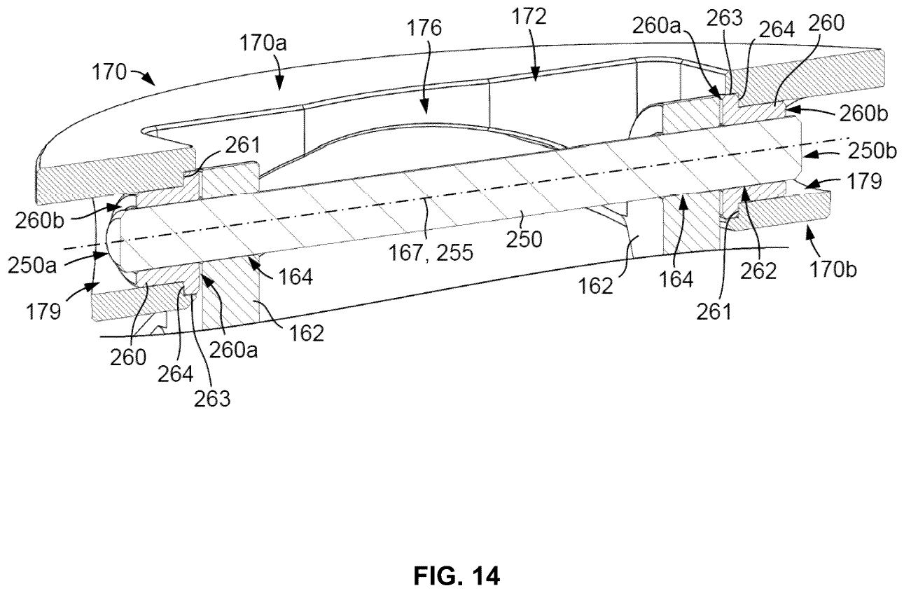

Radially outer surface 170c includes a radially extending annular shoulder 171 that extends circumferentially about axis 175. Annular shoulder 171 is defined by a planar surface disposed in a plane oriented perpendicular to axis 175 and axially faces toward inner side 170a. A plurality of keys or projections 173 extend axially (relative to axis 175) from shoulder 171 to inner side 170a. In this embodiment, the plurality of keys 173 are integrally formed on shoulder 171. In some embodiments, the plurality of keys 173 includes a pair of keys 173 that are circumferentially spaced from one another about axis 175 and that are positioned along annular shoulder 171 generally opposite rectangular portion 176 of central aperture 172 across axis 175. Specifically, as best shown in FIG. 12, if rectangular portion 176 is positioned to straddle the 12 o'clock position about axis 175, the pair of keys 173 may be positioned approximately at the 4 o'clock and 7 o'clock positions. Thus, rectangular portion 176 may be described as being positioned along a first radial side 140 of axis 175 and keys 173 may be described as being positioned along a second radial side 141 of axis 175, wherein first radial side 140 is radially opposite second radial side 140.

Keys 173 may have any suitable shape or dimensions. For instance, in the embodiment shown in FIGS. 10-12, keys 173 have a generally rectangular shape; however, other shapes are specifically contemplated (e.g., curved, circular, elliptical, triangular, etc.). In some embodiments, alignment ring 170 may have a single key 173 positioned along shoulder 171 (on the second radial side 141), or more than two keys 173 positioned along shoulder 171 (on the second radial side 141).

Referring now to FIG. 13, flapper 160 is pivotably attached to alignment ring 170 via pin 250 as previously described. Pin 250 may be inserted through apertures 164 in hinge ears 162 of flapper 160 and into receptacles 179 of hinge blocks 178 so that a longitudinal axis 255 of pin 250 is generally coaxially aligned with axis 167. As a result, flapper 160 may pivot or rotate about axis 167 relative to alignment ring 170 via pin 250, and the common axis 167 defines an axis of rotation for flapper 160 during operations.

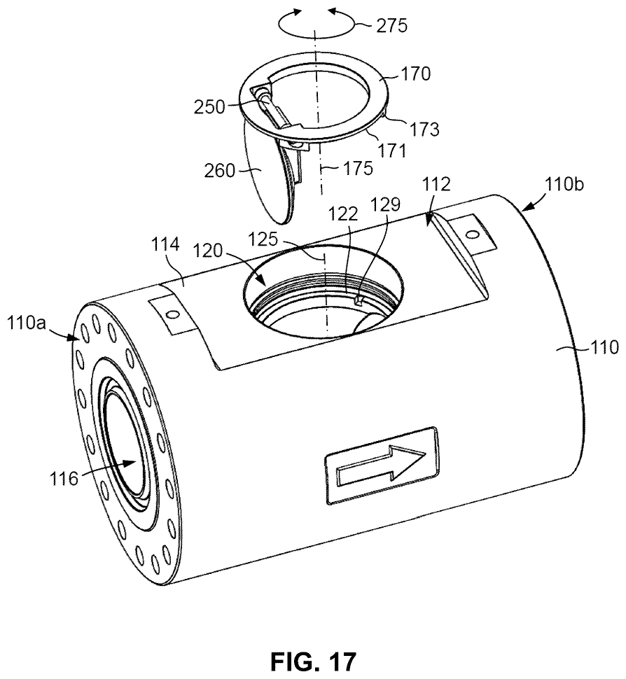

Referring now to FIG. 14, pin 250 may be inserted into receptacles 179 of hinge blocks 178 of alignment ring 170 via a pair of T-bushings 260. In particular, pin 250 is an elongate cylindrical shaft having a first end 250a and a second end 250b opposite first end 250a. Pin 250 is longitudinally aligned with axis 167 so that first end 250a is inserted into a first T-bushing 260 that is further inserted into one of receptacles 179 and second end 250b is inserted into a second T-bushing 260 that is further inserted into the other of receptacles 179.

Each T-bushing 260 is a hollow, cylindrical member that includes a first end 260a and a second end 260b spaced from first end 260a. In addition, each T-bushing 260 incudes a central throughbore 262 that extends between ends 260a, 260b. Further, a radially extending annular flange 263 is positioned at (or proximate to) first end 260a that defines a radially extending outer annular shoulder 264. Shoulder 264 of each T-bushing 260 may face toward second end 260b and away from first end 260a. Thus, as may be appreciated from FIG. 14, each T-bushing 260 may have a general T-shape in axial cross-section due to annular flange 263.

T-bushings 260 are inserted into receptacles 179 so that the outer annular shoulder 264 of each T-bushing 260 is engaged and abutted with a corresponding inner annular shoulder 261 defined in the corresponding receptacle 179. When pin 250 is inserted through apertures 164 of hinge ears 162 of flapper 160 and receptacles 179 via T-bushings 260, annular flange 263 of each T-bushing 260 may be engaged and captured axially between annular shoulder 261 of the corresponding receptacle 179 and the corresponding hinge ear 162 along aligned axes 167, 255. Thus, T-bushings 260 may be prevented from withdrawing from receptacles 179, so that the pivotal connection between flapper 160 and alignment ring 170 may be maintained during operations.

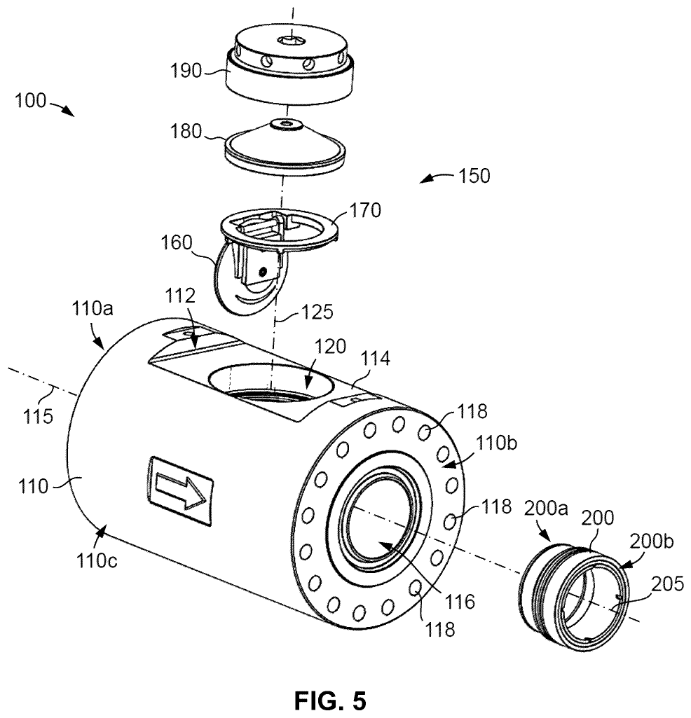

Referring now to FIGS. 13 and 14, during operations, flapper 160 may pivot about axis 167 relative to alignment ring 170 via pin 250. However, during this process, pin 250 may not slidingly engage the inner surfaces or walls of receptacles 179 in hinge blocks 178. Rather, T-bushings 260 may slide against the inner walls defining receptacles 179 so as to prevent wearing of the outer surface of pin 250 during operations. Without being limited to this or any other theory, a contact surface area between pin 250 and throughbores 262 of T-bushings 260 may be smaller than that between T-bushings 260 and receptacles 179. As a result, T-bushings 260 may experience a greater amount of wear than that of pin 250 as flapper 160 pivots about axis 167. Thus, T-bushings 260 may function as wear parts (e.g., sacrificial wear parts) that may increase the service life of pin 250. As such, T-bushings 260 may be inspected and replaced during maintenance or repair operations for check valve assembly 150 (FIG. 5). In some embodiments, pin 250 and T-bushings 260 may both be made of a metallic material (e.g., high-strength steel). In some embodiments, one or both of pin 250 and T-bushings 260 may be constructed of a non-metallic material, such as a polymer (e.g., an acetal polymer such as polyoxymethylene). In some embodiments, T-bushings 260 may be rotationally locked to pin 250 (e.g., about axes 167, 255) to prevent sliding contact therebetween, such as via a friction fit, keyed engagement, faceted engagement, etc.

By contrast, if T-bushings 260 were not installed in receptacles 179, about pin 250, pin 250 would directly engage with the inner walls of receptacles 179 so that the outer surface of pin 250 may experience wear during operations. Often, the torque exerted about axis 167 maybe uneven and pin 250 may experience bending moments along axis 167. As a result, pin 250 may wobble relative to axis 167 so that the outer surface of pin 250 may experience so-called “penciling” type wear in which the outer diameter of pin 250 may reduce to points at the ends 260a, 260b due to the contact with the inner walls defining receptacles 179. Such wear will eventually necessitate a replacement of pin 250 and potentially alignment ring 170, which may carry a substantially increased cost relative to simply replacing T-bushings 260 as previously described.

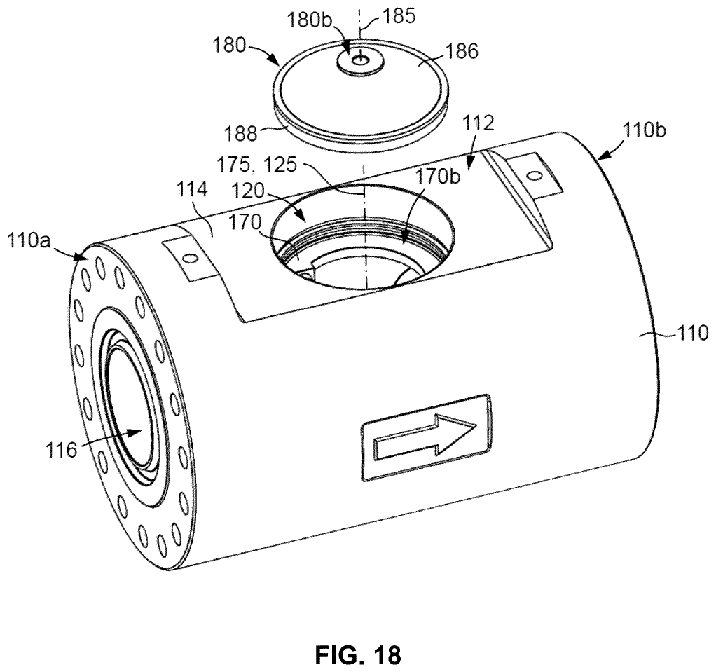

Referring now to FIG. 15, plug 180 is a generally cylindrical member that has a central or longitudinal axis 185, a first or inner end 180a, and a second or outer end 180b that is axially spaced (relative to axis 185) from inner end 180a. In addition, plug 180 includes a radially outer surface 180c that extends from inner end 180a to outer end 180b. Radially outer surface 180c includes a frustoconical surface 186 and a cylindrical surface 188. Frustoconical surface 186 is positioned axially (relative to axis 185) between cylindrical surface 188 and outer end 180b. Frustoconical surface 188 slopes or diverges radially outward from axis 185 when moving axially toward inner end 180a and away from outer end 180b. In addition, plug 180 includes a first recess 182 extending axially (relative to axis 185) into inner end 180a and a second recess 184 extending axially (relative to axis 185) into outer end 180b. As will be described in more detail below, first recess 182 provides clearance for flapper 160 or a component coupled thereto (e.g., weight 168) when flapper 160 is rotated along axis 167 (FIG. 14) relative to alignment ring 170 as previously described. Second recess 184 may be internally threaded so that a suitable tool (not shown) may be engaged therein to facilitate installation or withdrawal of plug 180 from access port 120 during operations.

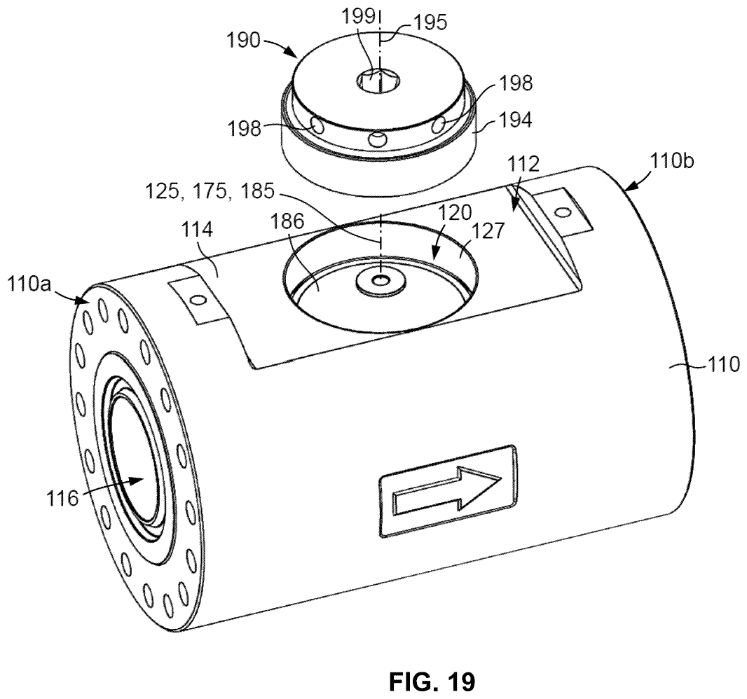

Referring now to FIG. 16, bonnet 190 is also a generally cylindrical member that has a central or longitudinal axis 195, a first or inner end 190a, and a second or outer end 190b that is axially opposite inner end 190a. In addition, bonnet 190 includes a radially outer surface 190c extending axially (relative to axis 195) from inner end 190a to outer end 190b. Radially outer surface 190c includes external threads 194 axially positioned at or proximate inner end 190a. Also, a plurality of spanner recesses 198 extend radially into bonnet 190 from radially outer surface 190c and are axially positioned (relative to axis 195) between external threads 194 and outer end 190b.

A through passage 192 extends axially (relative to axis 195) through bonnet 190 from inner end 190a to outer end 190b. Through passage 192 includes a frustoconical surface 196 extending from inner end 190a and an outer portion 199 extending from outer end 190b. Outer portion 199 has a hexagonal cross-section (although, other cross-sections or shapes are contemplated such as cylindrical, square, rectangular, triangular, etc.) so that a suitable tool (not shown) may be engaged therein to apply torque to bonnet 190 about axis 195 (e.g., such as during installation and/or removal of bonnet 190 from access port 120).

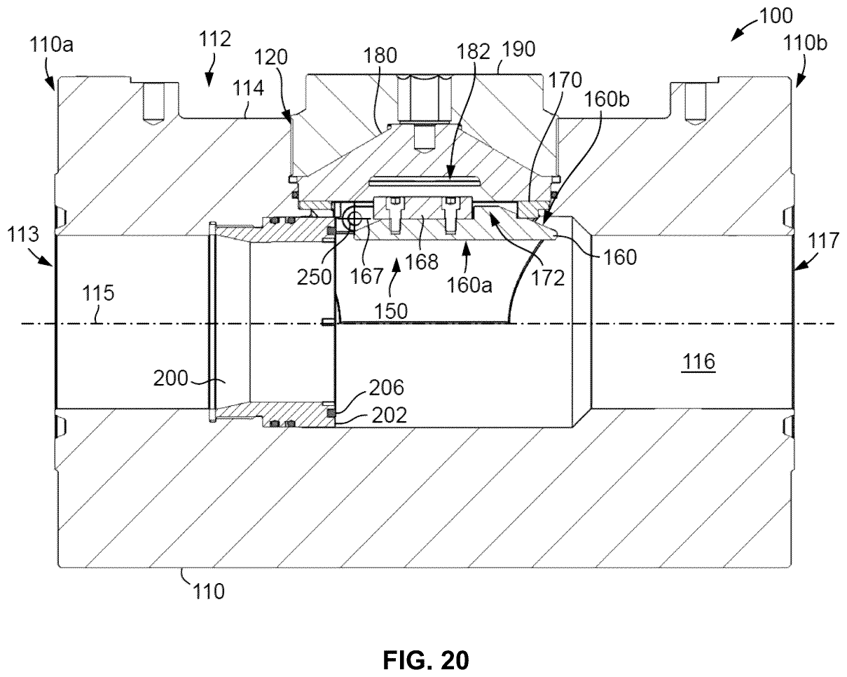

Referring now to FIGS. 17-19, a sequence of assembly steps for installing check valve assembly 150 within housing 110 is shown. Valve seat 200 (not shown in FIGS. 17-19, but see FIGS. 3 and 4) has already been installed in throughbore 116 in the manner previously described. Thereafter, each of the components of check valve assembly 150 are inserted into housing 110 via access port 120.

Initially, as shown in FIG. 17, the assembled alignment ring 170 and flapper 160 are inserted into access port 120 so that axis 175 of alignment ring 170 is generally coaxially aligned with the axis 125 of access port 120. In general, alignment ring 170 is inserted into access port 120 along the aligned axes 175, 125 until annular shoulder 171 on alignment ring 170 is engaged with the internal annular shoulder 122 defined the in access port 120 and flapper 160 hangs down into throughbore 116 to engage with valve seat 200 and particularly strike face 202 and/or annular seal member 206 (FIGS. 3 and 4).

To ensure proper alignment of flapper 160 and valve seat 200 (particular strike face 202 and annular seal member 206), alignment ring 170 is circumferentially rotated about the aligned axes 175, 125 (see arrow 275) until keys 173 projecting outward from the outer annular shoulder 171 align with and fall into the corresponding slots 129 defined in the internal annular shoulder 122. Thus, slots 129 may be shaped, numbered, and positioned to correspond with the shape, number, and position (respectively) of keys 173 so that when keys 173 are received within slots 129, flapper 160 is properly aligned with valve seat 200 so that front side 160a evenly (or substantially evenly) contacts strike face 202 and/or annular seal member 206 during operations (see e.g., FIGS. 3 and 4). Accordingly, keys 173 may also be more generally referred to as “flapper alignment members.” In addition, because keys 173 are formed along the outer annular shoulder 171 of alignment ring 170, misalignment of the one or more keys 173 with the one or more slots 129 may prevent outer annular shoulder 171 from fully seating against the internal annular shoulder 122. Thus, aligning and inserting keys 173 with the corresponding slots 129 also allows the outer annular shoulder 171 to fully engage with or seat against the internal annular shoulder 122 in access port 120.

In some embodiments, the number, circumferential spacing, and circumferential positions of keys 173 and the corresponding slots 129 about axes 175, 125 may be chosen so that alignment ring 170 may only be fully inserted (with keys 173 received in slots 129) in a single circumferential position or alignment in access port 120 relative to the aligned axes 175, 125. In this way, misalignment of flapper 160 is avoided during installation thereof into housing 110, and proper alignment of flapper 160 may more easily and consistently be achieved by a technician in the field.

Moving now to FIG. 18, after alignment ring 170 and flapper 160 are installed into housing 110 as previously described, plug 180 is inserted into access port 120 until inner end 180a is engaged or abutted with the outer side 170b of alignment ring 170. As shown in FIGS. 3 and 4, cylindrical surface 188 on plug 180 engages with one or more annular seal members (e.g., O-rings) that are positioned in the one or more seal grooves 128 of second portion 126 (FIGS. 6 and 7) of access port 120 so that fluids are prevented and/or restricted from leaking out of access port 120 and around plug 180 during operations.

Moving now to FIG. 19, after plug 180 is inserted within access port 120, bonnet 190 is threadably advanced into access port 120 to compress both plug 180 and alignment ring 170 into the internal shoulder 122 (FIGS. 3 and 4) along the aligned axes 125, 175, 185, 195. Specifically, as shown in FIGS. 3, 4, and 19, external threads 194 defined on radially outer surface 190c (FIG. 16) of bonnet 190 are threadably engaged with internal threads 127 of the outer portion 124 (FIGS. 6 and 7) of access port 120 until outer end 180a of plug 180 is received into through-passage 192 of bonnet 190 and the mating frustoconical surfaces 186, 196 of plug 180 and bonnet 190 are engaged with one another. The threaded advancement of bonnet 190 into access port 120 may continue until a desired torque rating or value is achieved (such as a sufficient torque that will maintain the position of the other alignment ring 170 and plug 180 against the operating pressures within housing 110 during operations). In some embodiments, a spanner wrench (not shown) may be engaged with a plurality of the spanner recesses 198 defined on bonnet 190 to rotate and threadably advance or withdraw bonnet 190 into or out of access port 120. Alternatively (or additionally) in some embodiments, a suitable tool (e.g., wrench) may be engaged with the hexagonal cross-section of outer portion 199 of through-passage 192 to threadably advance or withdraw bonnet 190 into or out of access port 120.

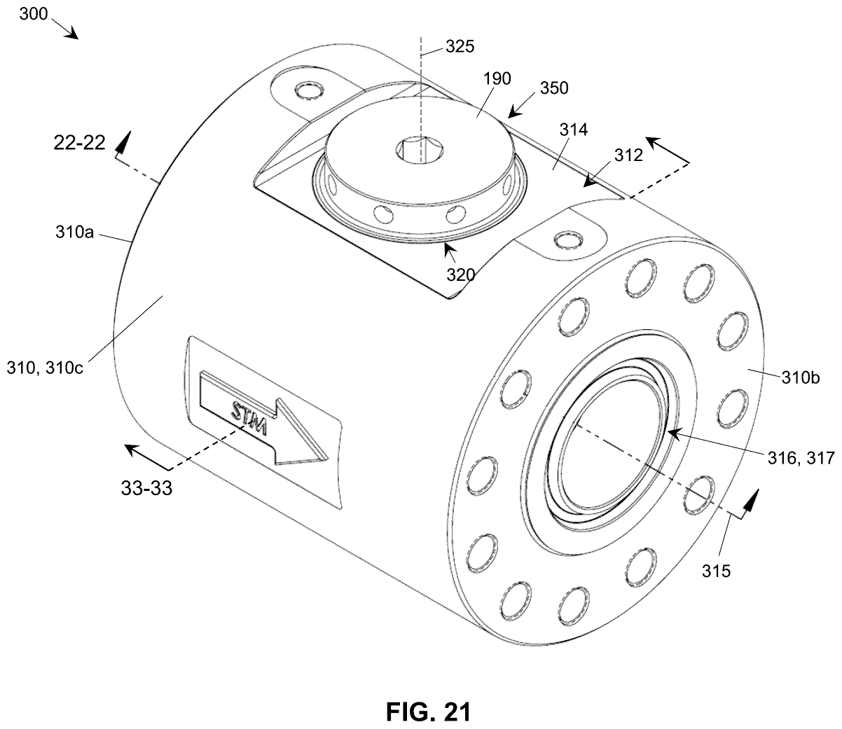

During operations, check valve 100 may transition between an open position shown in FIG. 20 and a closed position shown in FIG. 3. In particular when fluid flows through throughbore 116 of housing 110 from inlet 113 at upstream end 110a to outlet 117 at downstream end 110b, check valve 100 may be transitioned to the open position (FIG. 20) in which flapper 160 is rotated about axis 167 upward and toward access port 120 to thereby clear the flow path along throughbore 116. Central aperture 172 of alignment ring 170 and first recess 182 of plug 180 may at least partially receive back side 160b and weight 168 of flapper so as to allow flapper 160 to fully rotate about axis 167 to open the flow path in throughbore 116 when valve 100 is in the open position of FIG. 20.

Conversely, if the fluid flows along throughbore 116 from outlet 117 to inlet 113, the pressure on back side 160b of flapper 160 will increase above the pressure on front side 160a so that flapper 160 may rotated about axis 167 via pin 250 from the open position (FIG. 20) to the closed position (FIG. 3). In the closed position (FIG. 3), front side 160a of flapper 160 is engaged with strike face 202 and annular seal member 206 of valve seat 200 to thereby prevent and/or restrict the flow of fluid through valve seat 200 to upstream end 110a.

As previously described, during operations, weight 168 may be selected so as to adjust a total weight of flapper 160 to allow flapper 160 to fully transition between the fully opened and fully closed positions at the expected flow rates and/or pressures in throughbore 116. Specifically, if weight 168 is too heavy, the fluid flow in throughbore 116 from upstream end 110a to downstream end 110b will not be sufficient to fully lift the flapper to the open position shown in FIG. 20. As a result, flapper 160 may not fully open so as to obstruct the flow of fluid in throughbore 116 and/or flapper 160 may flutter or pivotably reciprocate about axis 167 between the open (FIG. 20) and closed (FIG. 3) positions, which may accelerate wear (e.g., of pin 250, T-bushings 260, etc.). Conversely, if weight 168 is too light, flapper 160 may violently slam into alignment ring 170, plug 180, and bonnet 190 when transitioning to the open position of FIG. 20, which may lead to failure. Accordingly, selecting the size of weight 168 to attach to back side 160b of flapper 160 may effectively “tune” the movement of flapper 160 for the particular fluid pressures and flow rates in housing 110 so as to ensure proper performance and maximum service life of check valve 100.

In addition, check valve 100 (and particularly check valve assembly 150) may be configured to allow removal and replacement of weight 168 without removing alignment ring 170 and flapper 160 from housing 110. Specifically, a technician may simply remove bonnet 190 and plug 180 from access port 120 and then may access back side 160b of flapper 160 via central aperture 172 so as to remove, install, and/or replace weight 168 for purposes of tuning flapper 160 as previously described above. Thus, a technician may more easily and efficiently perform these operations to adjust the weight of flapper 160 in the field.

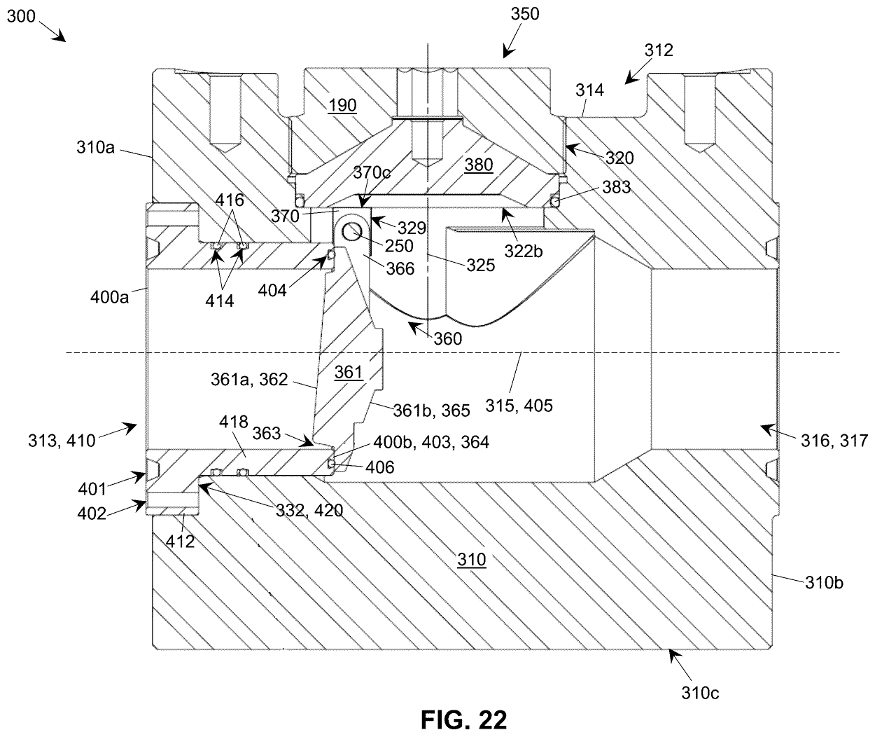

Referring now to FIGS. 21-24, an embodiment of a check valve 300 for use with hydraulic fracturing system 10 of FIG. 1 in place of check valve 100 is shown. Check valve 300 is similar to check valve 100. In particular, check valve 300 includes a body or housing 310 and a check valve assembly 350 (or more simply “valve assembly” 350) at least partially positioned in housing 310.

Similar to housing 110 previously described, housing 310 is a generally elongate cylindrical body that includes a central or longitudinal axis 315, a first or upstream end 310a, and a second or downstream end 310b axially opposite upstream end 310a (relative to axis 315). In addition, housing 310 includes a radially outer surface 310c extending axially between ends 310a, 310b. In the illustrated embodiment, radially outer surface 310c is a generally cylindrical surface; however, other shapes or curvatures are contemplated herein (such as square, rectangular, or polygonal cross-sections). A throughbore 316 also extends axially (relative to axis 315) through housing 310 from upstream end 310a to downstream end 310b so as to define an inlet 313 at upstream end 310a and an outlet 317 at downstream end 310b.

A radial recess 312 is defined along radially outer surface 310c and extends radially inward toward axis 315. Recess 312 is defined by an axially extending planar surface 314 oriented parallel to axis 315. An access port 320 extends radially (relative to axis 315) from planar surface 314 to throughbore 316. In particular, access port 320 extends along a central or longitudinal axis 325 that may be orthogonal or perpendicular to axis 315 so that axes 315, 325 lie within and/or define a plane (not shown). Access port 320 is axially positioned between ends 310a, 310b, and in this embodiment, is positioned substantially equidistant between ends 310a, 310b.

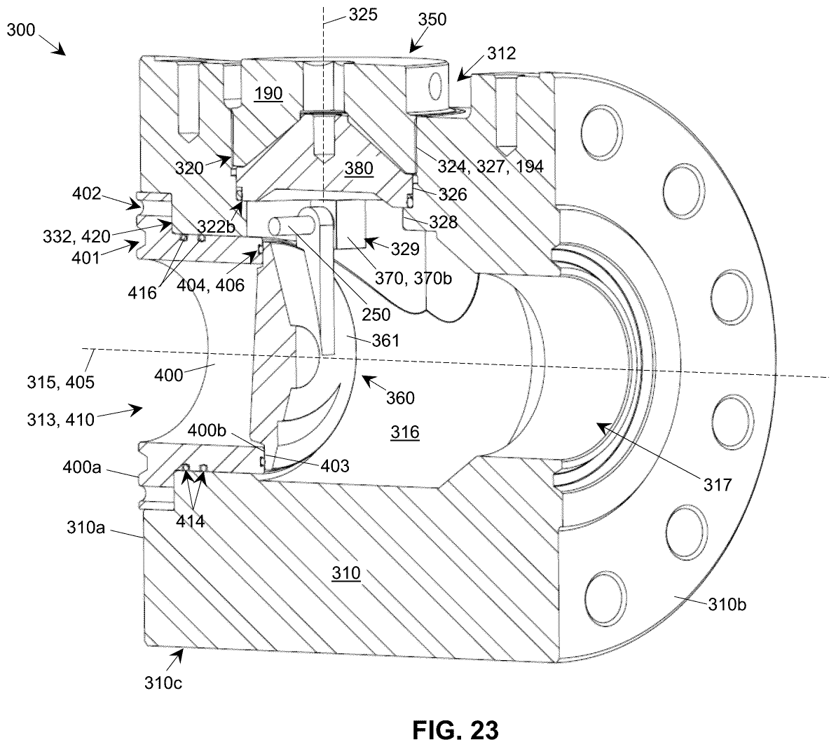

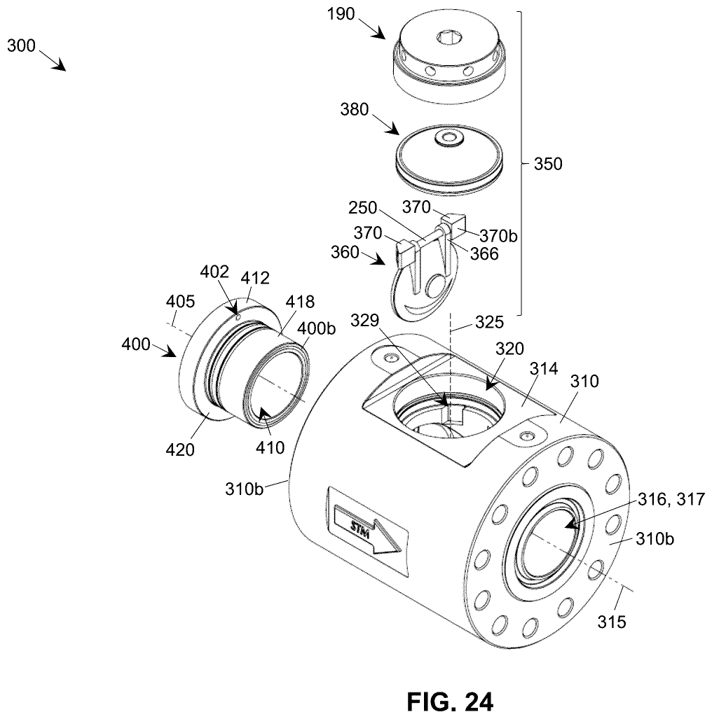

As shown in FIGS. 22 and 23, an internal, radially inwardly extending annular shoulder 332 is provided along throughbore 316 and is axially positioned (relative to axis 315) between access port 320 and upstream end 310a. In this embodiment, shoulder 332 is defined by an annular planar surface disposed in a plane oriented perpendicular to axis 315 and facing axially toward upstream end 310a. Accordingly, the inner diameter of throughbore 316 decreases moving axially from upstream end 310a across shoulder 332.

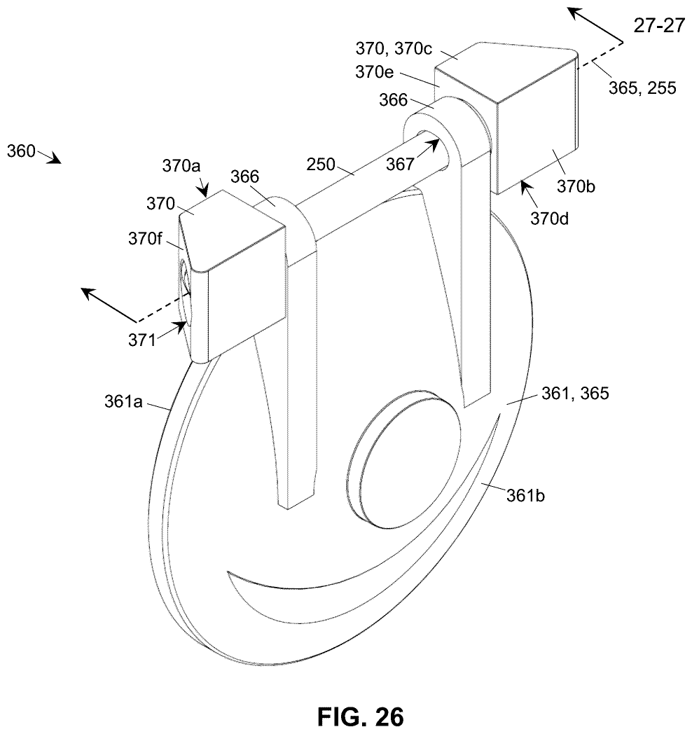

Referring now to FIG. 25, access port 320 is shown in more detail. In particular, access port 320 includes a first or radially outer portion 324 (relative to axis 315) that extends axially (relative to axis 325) from planar surface 314 to a first annular shoulder 322a, a second or radially intermediate portion 326 extending axially from first annular shoulder 322a to a second annular shoulder 322b, and a third or radially inner portion 328 (relative to axis 315) extending axially from second annular shoulder 322b to throughbore 316. In this embodiment, the radially inner surface of access port 320 is generally cylindrical along each portion 324, 326, 328. First portion 324 of access port 320 includes internal threads 327.

In this embodiment, each shoulder 322a, 322b is defined by a planar surface disposed in a plane oriented perpendicular to axis 325. First annular shoulder 322a extends radially inward (relative to axis 325) from first portion 324 to second portion 326, and second annular shoulder 322b extends radially inward (relative to axis 325) from second portion 326 to third portion 328. Thus, each shoulder 322a, 322b generally faces axially upward toward planar surface 314, and further, the inner diameter of access port 320 generally decreases moving from first portion 324 to second portion 326, and decreases moving from second portion 326 to third portion 328.

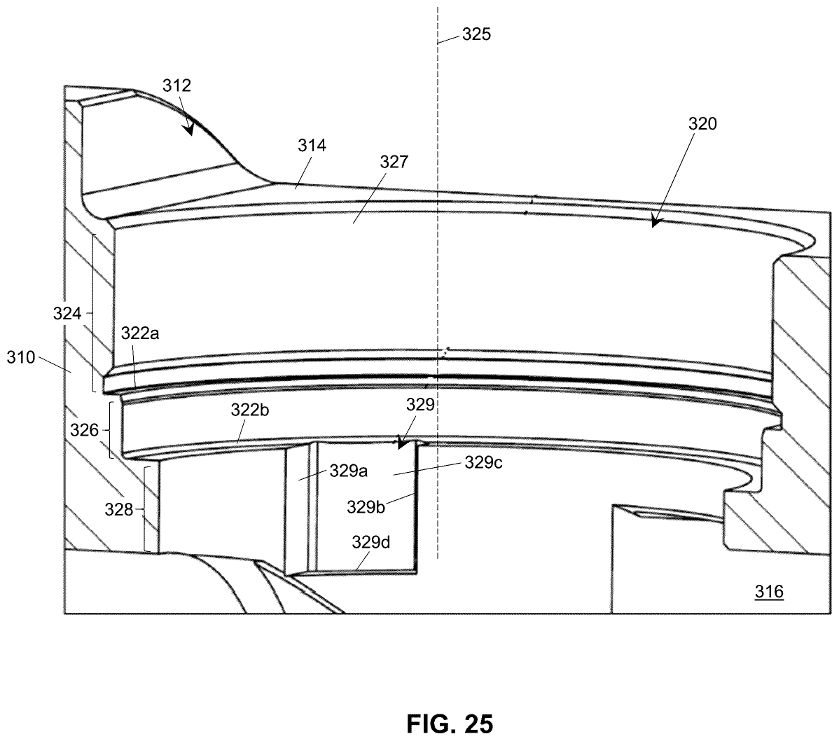

A pair of circumferentially-spaced, recesses or slots 329 extending axially (relative to axis 325) from second annular shoulder 322b along third portion 328 toward (but not to) throughbore 316. In addition, recesses 329 extend generally radially outwardly from the radially inner cylindrical surface defining third portion 328 of access port 320. As best shown in FIGS. 24 and 25, in this embodiment, each recess 329 has a generally prismatic, trapezoidal shape defined by a plurality of planar surfaces. More specifically, as best shown in FIG. 25, each recess 329 is defined by a first or upstream planar surface 329a, a second or downstream planar surface 329b, a third or outer planar surface 329c, and a fourth or lower planar surface 329d. Each surface 329a, 329b, 329c extends axially (relative to axis 325) from second annular shoulder 322b to lower surface 329d. In addition, surfaces 329a, 329b are oriented parallel to each other, and each surface 329a, 329b is disposed in a plane oriented perpendicular to axis 315 and parallel to axis 325. Further, each surface 329a, 329b, 329d extends generally radially outward (relative to axis 325) from the radially inner cylindrical surface defining third portion 328 of access port 320 to third planar surface 329c. Lower surface 329c is disposed in a plane oriented perpendicular to axis 325 and parallel to axis 315, and thus, is oriented parallel to the planar surface defining second annular shoulder 322b. In this embodiment, outer planar surface 329c generally extends circumferentially about axis 325, is oriented at an obtuse angle relative to upstream planar surface 329a, is oriented at an acute angle relative to downstream planar surface 329b, and is oriented perpendicular to lower surface 329d.

Referring again to FIGS. 22-24, check valve assembly 350 also includes a flapper assembly 360 including a flapper (or valve element) 361 pivotably coupled to a pair of hinge blocks 370 via a pin 250 as previously described. In addition, check valve assembly 350 includes a plug 380, a bonnet 190, and a valve seat 400. Bonnet 190 is as previously described. Each of the remaining components (e.g., plug 380 and valve seat 400) are described in more detail below.

Referring now to FIGS. 22-24, valve seat 400 is a generally cylindrical member that includes a central or longitudinal axis 405, a first or upstream end 400a, and a second or downstream end 400b axially spaced (relative to axis 405) from upstream end 400a. A throughbore 410 extends axially (relative to axis 405) from upstream end 400a to downstream end 400b. Valve seat 400 has a generally T-shaped cross-sectional geometry including a first or upstream cylindrical portion 412 extending axially from first end 400a to an annular shoulder 420 and a second or downstream cylindrical portion 418 extending axially from annular shoulder 420 to downstream end 400b. Upstream portion 412 and downstream portion 418 have cylindrical radially outer surfaces. However, downstream cylindrical portion 418 has a smaller outer diameter than upstream portion 412 such that that annular shoulder 420 extends radially inwardly moving axially from upstream portion 412 to downstream portion 418. In this embodiment, annular shoulder 420 is defined by a planar surface disposed in a plane oriented perpendicular to axis 405 and faces axially toward second end 400b. As best shown in FIGS. 22 and 23, annular shoulder 420 axially abuts and engages mating annular shoulder 332 when valve seat 400 is seated in throughbore 316.

In this embodiment, valve seat 400 is slidingly disposed and seated within throughbore 316. More specifically, the radially outer surface of upstream portion 412 of valve seat 400 slidingly engages the radially inner cylindrical surface of housing 310 defining throughbore 316 between end 310a and shoulder 332, and downstream portion 418 of valve seat 400 slidingly engages the radially inner cylindrical surface of housing 310 defining throughbore 316 and extending axially (relative to axis 315) from shoulder 332 toward end 310b. The radially outer surface of downstream portion 418 includes a pair of axially spaced (relative to axis 315) annular seal grooves 414. Each annular seal groove 414 receives an annular seal member 416 (e.g., an O-ring or other annular seal member) therein. Annular seal members 416 form annular seals between valve seat 400 and housing 310.

As best shown in FIGS. 22 and 23, upstream end 400a includes an annular groove 401 disposed about throughbore 410 and a plurality of circumferentially-spaced internally threaded bores 402. An annular seal or gasket (not shown) is seated in annular groove 401 for forming an annular seal between upstream end 400a and an adjacent conduit (or other equipment) coupled to upstream end 310a of housing 310. Bores 402 extend axially (relative to axis 405) from upstream end 400a to annular shoulder 420. Externally threaded lift eyes can be threaded into mating internally threaded bores 402 to aid in pulling valve seat 400 from throughbore 316.

Downstream end 400b of valve seat 400 includes or defines an annular strike face 403. In this embodiment, annular strike face 403 is defined by an annular planar surface disposed in a plane oriented perpendicular to axis 405 (although, other shapes or configurations are contemplated, such as a frustoconical surface). An annular groove 404 extends axially (relative to axis 405) into strike face 403 and extends circumferentially about axis 405. An annular seal member 406 is seated in mating groove 404 and selectively engages with flapper 361 during operations to prevent fluid flow between flapper 361 and strike face 403 along throughbore 316 (FIG. 22). Annular seal member 406 may comprise any suitable material such as, for instance, a carbonaceous material, elastomeric material, metallic material, etc. For instance, in some embodiments, seal member 406 may comprise an elastomeric face seal.

Referring still to FIGS. 22 and 23, valve seat 400 is slidably disposed within throughbore 116 with axis 405 oriented parallel to and coaxially aligned with axis 315. Specifically, valve seat 400 is inserted axially (relative to axes 315, 405) into throughbore 316 via inlet 313 at upstream end 310a until annular shoulder 420 of valve seat 400 axially abuts and engages mating annular shoulder 332 of housing 310. As previously described, the radially outer cylindrical surfaces of upstream portion 412 and downstream portion 418 slidingly engage the radially inner surfaces of housing 310 with annular seal members 416 sealingly engaging valve seat 400 and housing 310 to prevent and/or restrict fluid flow between valve seat 400 and housing 310 during operations. Thereafter, upstream end 310a of housing 310 is attached to an adjacent conduit (or other equipment), which axially compresses (relative to axes 315, 405) annular shoulders 420, 332 together to fully seat valve seat 400 within throughbore 316 of housing 310. As valve seat 400 is installed in housing 310 via inlet 313 at upstream end 310a, valve seat 400 may be referred to as a “side entry” valve seat.

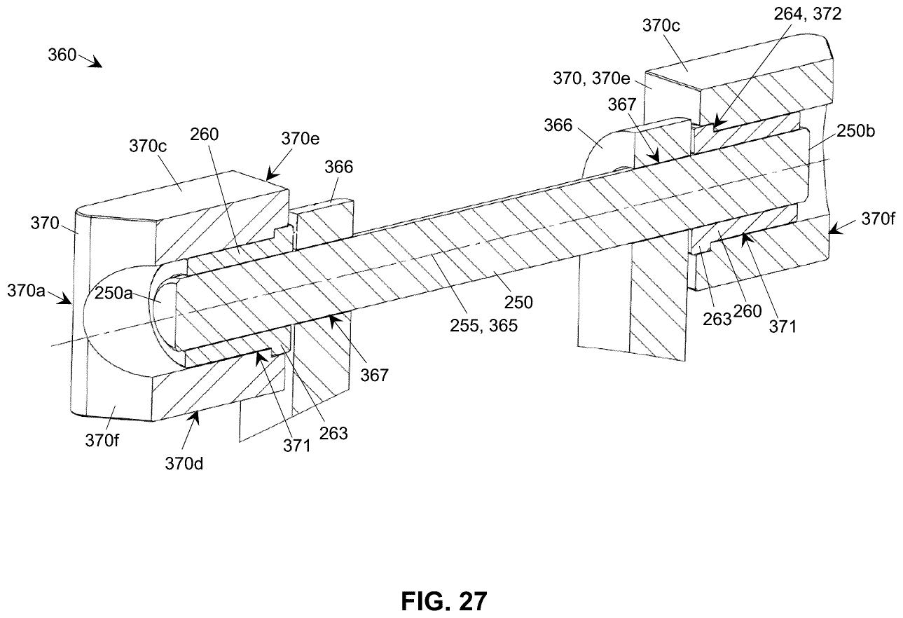

Referring now to FIGS. 22 and 26, flapper 361 is a disc-shaped member having a first or front side 361a and a second or back side 361b opposite front side 361a. In this embodiment, front side 361a includes a central planar surface 362 and an annular recess 363 disposed about central planar surface 362 along the radially outer periphery of front side 361a. Annular recess 363 defines an annular sealing surface 364 on front side 361a configured to mate and engage with valve seat 400, and in particular, to mate and engage strike face 403 and annular seal member 406 during operations to prevent and/or restrict flow along throughbore 316 (FIG. 22). Thus, annular sealing surface 364 is a planar surface disposed in a plane oriented perpendicular to axes 315, 405 when flapper 361 is in the closed position shown in FIG. 22. Back side 361b may include a generally convexly (bowed outwardly) curved surface 365 that may have any suitable curvature geometry (e.g., spherical, ellipsoid, etc.).

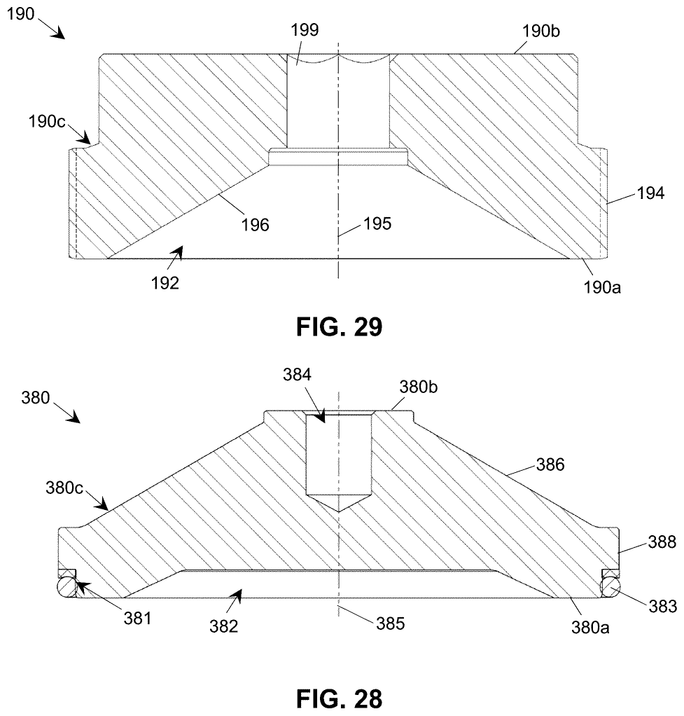

Referring now to FIGS. 26 and 27, a pair of hinge ears or projections 366 extend outwardly from back side 361b. Hinge ears 366 may be integrally formed with flapper 361 such as shown in FIG. 26, or may be separately formed and subsequently attached (e.g., via screws, bolts, rivets, welding, etc.) to flapper 361. Each of hinge ears 366 includes an aperture 367 extending therethrough. Hinge ears 366 are arranged and positioned on flapper 361 such that apertures 367 are spaced apart and aligned along a central axis 365.

Referring still to FIGS. 26 and 27, in this embodiment, flapper 361 is not pivotally coupled to an alignment or halo ring (e.g., ring 170). Rather, in this embodiment, flapper 361 is pivotally coupled to the pair of hinge blocks 370. As will be described in more detail, hinge blocks 370 are similar to hinge blocks 178 previously described but are not coupled to an alignment or halo ring, and further, hinge blocks 370 function similar to keys 173 to position and orient flapper 361 within housing 310. Accordingly, hinge blocks 370 may also be more generally referred to as “flapper alignment members.”

Each hinge block 370 is sized and shape to mate with a corresponding recess 329 in second annular shoulder 322b disposed along access port 320. Thus, each hinge block 370 has a generally trapezoidal prismatic shape defined by a plurality of planar surfaces. More specifically, each hinge block 370 includes a first or upstream planar surface 370a, a second or downstream planar surface 370b, a third or upper planar surface 370c, a fourth or lower planar surface 370d, a fifth or inner planar surface 370e, and a sixth or outer planar surface 370f. Each surface 370a, 370b, 370c, 370d extends axially (relative to axis 365) from inner planar surface 370e to outer planar surface 370f. In addition, surfaces 370a, 370b are oriented parallel to each other and perpendicular to surfaces 370c, 370d, 370e, and extend from surface 370c to surface 370d. Outer surface 370f is oriented at an obtuse angle relative to upstream surface 370a, oriented at an acute angle relative to downstream surface 370a, and oriented perpendicular to upper surface 370c and lower surface 370d. Thus, planar outer surface 370f is not oriented parallel to planar inner surface 370e.

Each hinge block 370 is slidingly and removably seated in a mating, corresponding recess 329 in second annular shoulder 322b. In particular, upstream planar surface 370a of each hinge block 370 is flush with and slidingly engages mating upstream planar surface 329a of the corresponding recess 329, downstream planar surface 370b of each hinge block 370 is flush with and slidingly engages mating downstream planar surface 329b of the corresponding recess 329, lower planar surface 370d of each hinge block 370 is flush with and slidingly engages mating lower planar surface 329d of the corresponding recess 329, and outer planar surface 370f of each hinge block 370 is flush with and slidingly engages mating outer planar surface 329c of the corresponding recess 329. As will be described in more detail below, seating of hinge blocks 370 in recesses 329 properly aligns flapper 361 within throughbore 316 such that it can pivot freely between a closed position (FIG. 22) sealingly engaging strike face 403 at downstream end 400b of valve seat 400, thereby preventing flow through throughbore 316 from downstream end 310b to upstream end 310a, and an open position rotated away from engagement with strike face 403, thereby allowing flow through throughbore 316 from upstream end 310a to downstream end 310b. As best shown in FIG. 22, when hinge blocks 370 are seated in the corresponding recesses 329, upper planar surfaces 370c of hinge blocks 370 are coplanar and generally contiguous with second annular shoulder 322b.

As best shown in FIG. 27, each hinge block 370 includes a receptacle 371 extending axially (relative to axis 365) from inner surface 370e to outer surface 370f. Each receptacle 371 is coaxially aligned with axis 365 and apertures 367 in hinge ears 366.

Referring again to FIGS. 26 and 27, flapper 361 is pivotably attached to hinge blocks 370 via pin 250. Pin 250 extends through apertures 367 in hinge ears 366 of flapper 361 and into receptacles 371 of hinge blocks 370 so that a longitudinal axis 255 of pin 250 is generally coaxially aligned with axis 365. As a result, flapper 361 may pivot or rotate about axes 255, 365 relative to hinge blocks 370 via pin 250 during operations.

Referring now to FIG. 27, pin 250 may be inserted into receptacles 371 of hinge blocks 370 via a pair of T-bushings 260. Pin 250 and T-bushings 260 are as previously described. Pin 250 is coaxially aligned with axis 365 so that first end 250a is inserted into a first T-bushing 260 that is further inserted into one of receptacles 371 and second end 250b is inserted into a second T-bushing 260 that is further inserted into the other of the receptacles 371.

T-bushings 260 are as previously described. T-bushings 260 are inserted into receptacles 371 so that outer annular shoulder 264 of each T-bushing 260 is engaged and abutted with a corresponding inner annular shoulder 372 defined in the corresponding receptacle 371. When pin 250 is inserted through apertures 367 of hinge ears 366 of flapper 361 and receptacles 371 via T-bushings 260, annular flange 263 of each T-bushing 260 engages and is captured axially between annular shoulder 372 of the corresponding receptacle 371 and the corresponding hinge ear 366 along the aligned axes 365, 255. Thus, T-bushings 260 may be prevented from withdrawing from receptacles 371, so that the pivotal connection between flapper 361 and hinge blocks 370 may be maintained during operations.

Referring again to FIGS. 26 and 27, during operations, flapper 361 may pivot about axes 255, 365 relative to hinge blocks 370 via pin 250. However, during this process, pin 250 does not slidingly engage the inner surfaces or walls of hinge blocks 370 defining receptacles 371. Rather, T-bushings 260 slide against the inner walls defining receptacles 371 so as to prevent wearing of the outer surface of pin 250 during operations. Without being limited to this or any other theory, a contact surface area between pin 250 and throughbores 262 of T-bushings 260 may be smaller than that between T-bushings 260 and receptacles 371. As a result, T-bushings 260 may experience a greater amount of wear than that of pin 250 as flapper 361 pivots about axis 365. Thus, T-bushings 260 may function as wear parts (e.g., sacrificial wear parts) that may increase the service life of pin 250. As such, T-bushings 260 may be inspected and replaced during maintenance or repair operations for check valve assembly 350 (FIG. 24). In some embodiments, T-bushings 260 may be rotationally locked to pin 250 (e.g., about axes 365, 255) to prevent sliding contact therebetween, such as via a friction fit, keyed engagement, faceted engagement, etc.

By contrast, if T-bushings 260 were not installed in receptacles 371 about pin 250, pin 250 would directly engage with the inner walls defining receptacles 371 so that the outer surface of pin 250 may experience wear during operations. Often, the torque exerted about axis 365 maybe uneven and pin 250 may experience bending moments along axis 365. As a result, pin 250 may wobble relative to axis 365 so that the outer surface of pin 250 may experience “penciling” type wear as previously described. Such wear may eventually necessitate a replacement of pin 250 and potentially one or both of hinge blocks 370, which would carry a substantially increased cost relative to simply replacing T-bushings 260 as previously described.

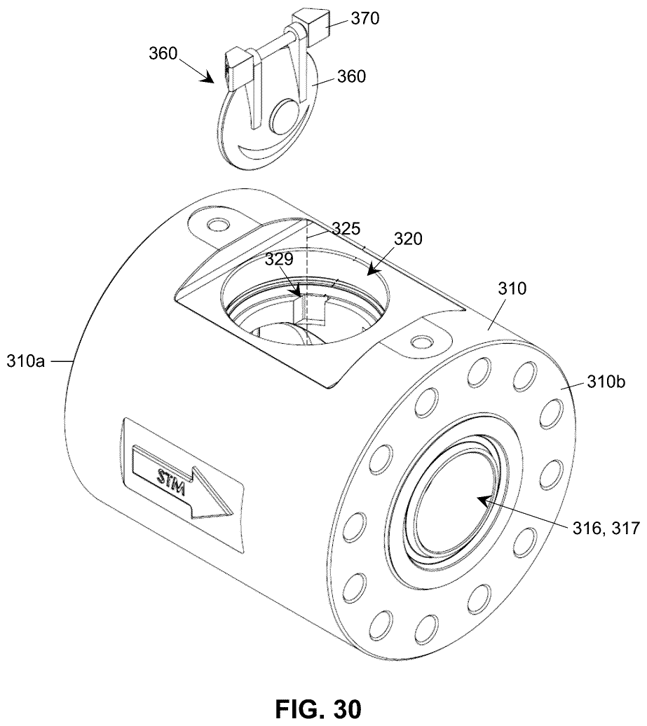

Referring now to FIG. 28, plug 380 is substantially the same as plug 180 previously described. In particular, plug 380 is a generally cylindrical member that has a central or longitudinal axis 385, a first or inner end 380a, and a second or outer end 380b that is axially spaced (relative to axis 385) from inner end 380a. In addition, plug 380 includes a radially outer surface 380c that extends from inner end 380a to outer end 380b. Radially outer surface 380c includes a frustoconical surface 386 and a cylindrical surface 388. Frustoconical surface 386 is positioned axially (relative to axis 385) between cylindrical surface 388 and outer end 380b. Frustoconical surface 388 slopes or diverges radially outward from axis 385 moving axially toward inner end 380a and away from outer end 380b. In addition, plug 380 includes a first recess 382 extending axially (relative to axis 385) into inner end 380a and a second recess 384 extending axially (relative to axis 385) into outer end 380b. As will be described in more detail below, first recess 382 provides clearance for flapper 361 when flapper 361 is rotated along axis 365 relative to hinge blocks 370 as previously described. Second recess 384 may be internally threaded so that a suitable tool (not shown) may be engaged therein to facilitate installation or withdrawal of plug 380 from access port 320 during operations. However, unlike plug 180 previously described, in this embodiment, an annular seal groove 381 is disposed in cylindrical surface 388 at inner end 380a and an annular seal member 383 (e.g., an O-ring or other annular seal member) seated in seal groove 381. As shown in FIG. 22, plug 380 is seated in access port 320 with inner end 380a compressed against second annular shoulder 322b and cylindrical surface 388 slidingly engaging the cylindrical inner surface defining intermediate portion 326 of access port 320. Seal member 383 sealingly engages plug 380, second annular shoulder 322b, and the cylindrical inner surface defining intermediate portion 326 of access port 320, thereby forming an annular seal between housing 310 and plug 380. It should be appreciated that when inner end 380a of plug 380 is seated against second annular shoulder 322b, inner end 380a is also seated against upper surfaces 370c of hinge blocks 370, thereby preventing hinge blocks 370 from exiting recesses 329.

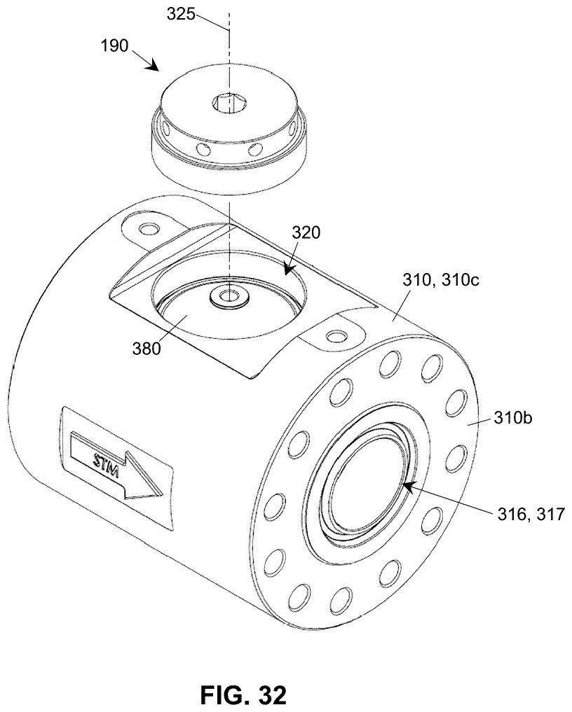

Referring now to FIGS. 30-32, a sequence of assembly steps for installing check valve assembly 350 within housing 310 is shown. Valve seat 400 (not shown in FIGS. 30-32, but see FIGS. 22 and 23) may have already been installed in throughbore 316 in the manner previously described. Thereafter, each of the components of check valve assembly 350 may be inserted into housing 310 via access port 320.

Initially, as shown in FIG. 30, flapper assembly 360 is inserted axially (relative to axis 325) into access port 320 with front side 361a generally facing downstream end 400b of valve seat 400 (already seated in housing 310) and each hinge block 370 aligned with a corresponding recess 329 in second annular shoulder 322b. Flapper assembly 360 is axially advanced (relative to axis 325) through access port 320 until hinge blocks 370 are seated in recesses 329 as previously described and flapper 361 hangs down into throughbore 316 to engage with downstream end 400b of valve seat 400 (and more particularly strike face 403 and annular seal member 406) as shown in FIGS. 22 and 23.

To ensure proper alignment of flapper 361 and valve seat 400 (particular strike face 403 and annular seal member 406), flapper assembly 360 may be rotated about axis 325 until hinge blocks 370 align with and fall into corresponding, mating recesses 329 in second annular shoulder 322b. Thus, recesses 329 are shaped and positioned to correspond with the shape and position (respectively) of hinge blocks 370 so that when hinge blocks 370 are received within recesses 329, flapper 361 is properly aligned with valve seat 400 so that sealing surface 364 evenly (or substantially evenly) contacts strike face 403 and/or annular seal member 406 during operations (see e.g., FIGS. 22 and 23). It should also be appreciated that misalignment of the one or more hinge blocks 370 with one or more recesses 329 prevents both hinge blocks 370 from fully seating within recesses 329 against lower surface 329d. Thus, aligning and inserting hinge blocks 370 with and within, respectively, the corresponding mating recesses 329 also allows hinge blocks 370 to fully seat within recesses 329. Due to the position and geometry of hinge blocks 370 and mating recesses 329, hinge blocks 370 can only be fully inserted and seated within recesses 329 in a single circumferential position relative to access port 320 and axis 325, such circumferentially position and associated full seating of hinge blocks 370 in mating recesses 329 results in the proper alignment and positioning of flapper 361 relative to valve seat 400. In this way, misalignment of flapper 361 is avoided during installation thereof into housing 310, and proper alignment of flapper 361 may more easily and consistently be achieved by a technician in the field.

Moving now to FIG. 31, after installation of flapper assembly 360 into housing 310 as previously described, plug 380 is coaxially aligned with access port 320 (i.e., axes 325, 385 are coaxially aligned), and then axially inserted into access port 320 (relative to axis 325) until inner end 380a is engages second annular shoulder 322b along access port 320. As shown in FIGS. 22 and 23, cylindrical surface 388 on plug 380 slidingly engages the cylindrical surface defining intermediate section 326 of access port 320. As previously described, seal member 383 sealingly engages plug 380, second annular shoulder 322b, and the cylindrical inner surface defining intermediate portion 326 of access port 320, thereby forming an annular seal between housing 310 and plug 380 so that fluids are prevented and/or restricted from leaking out of access port 320 and around plug 380 during operations.

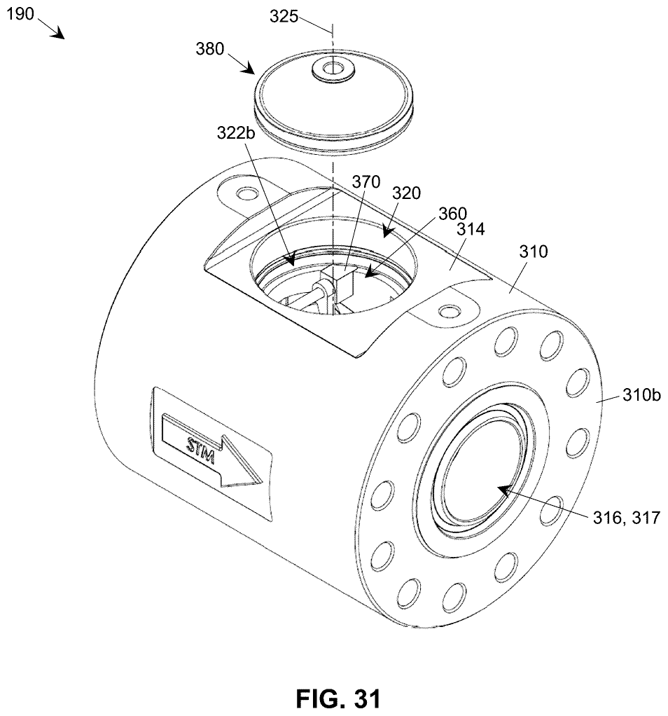

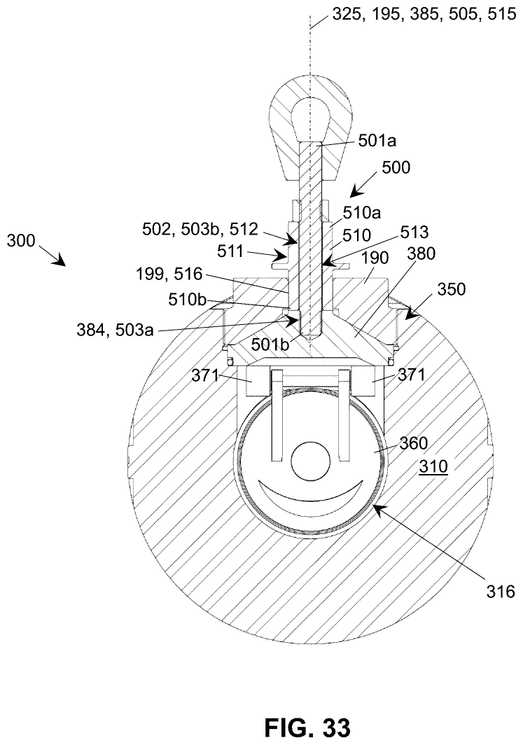

Moving now to FIG. 32, after plug 380 is inserted within access port 320, bonnet 190 is coaxially aligned with access port 320 (i.e., axes 325, 195 are coaxially aligned), threadably advanced into access port 320 to compress plug 380 into second annular shoulder 322b (FIGS. 22 and 23) along aligned axes 325, 195, 385. Specifically, as shown in FIGS. 22 and 23, threads 194 defined on radially outer surface 190c (FIG. 29) of bonnet 190 are threadably engaged with mating internal threads 327 of outer portion 324 of access port 320 until outer end 380a of plug 380 is received into through-passage 192 of bonnet 190 and mating frustoconical surfaces 386, 196 of plug 380 and bonnet 190, respectively, are engaged with one another. The threaded advancement of bonnet 190 into access port 320 may continue until a desired torque rating or value is achieved (such as a sufficient torque that will maintain the position of plug 380 and flapper assembly 360 against the operating pressures within housing 310 during operations). In some embodiments, a spanner wrench (not shown) may be engaged with a plurality of the spanner recesses 198 defined on bonnet 190 to rotate and threadably advance or withdraw bonnet 190 into or out of access port 320. Alternatively (or additionally) in some embodiments, a suitable tool (e.g., wrench) may engage the internal threads of second recess 384 of plug 380 and/or the hexagonal cross-section of outer portion 199 of through-passage 192 of bonnet 190 to advance or withdraw plug 380 and/or bonnet 190 into or out of access port 320. For example, referring now to FIG. 33, a combination plug and bonnet installation and removal tool 500 is shown positively engaging both plug 380 via internal threads of second recess 384 and bonnet 190 via outer portion 199 of through-passage 192. In this embodiment tool 500 includes a generally cylindrical shaft 501 and an annular sleeve 510 rotatably mounted to shaft 501.

Shaft 501 has a central or longitudinal axis 505, a first or lower end 501a, a second or upper end 501b, and a radially outer surface 502 extending axially from lower end 501a to upper end 501b. Outer surface 502 of shaft 501 includes an externally threaded cylindrical lower portion 503a extending axially from lower end 501a and a cylindrical surface 503b extending axially from lower portion 503a. Externally threaded lower portion 503a is configured to threadably engage mating internal threads of second recess 384 of plug 380.

Sleeve 510 has a central or longitudinal axis 515 coaxially aligned with axis 505, a first or lower end 510a, a second or upper end 510b, a radially outer surface 511 extending axially from lower end 510a to upper end 510b, and a radially inner surface 512 extending from lower end 510a to upper end 510b. Inner surface 512 defines a throughbore 513 extending axially through sleeve 510 from lower end 510a to upper end 510b. Inner surface 512 is a cylindrical surface that slidingly engages mating cylindrical surface 503b of shaft 501, thereby allowing sleeve 510 and shaft 501 to rotate relative to each other about axis 505, 515. Outer surface 511 includes a hexagonal prismatic surface 516 extending from lower end 510b and configured to engage mating hexagonal profile of outer portion 199 of through passage 192 of bonnet 190.

Referring still to FIG. 33, tool 500 can be used to install plug 380 and bonnet 190, and remove plug 380 and bonnet 190. More specifically, to install plug 380 and bonnet 190, axes 195, 385, 505, 515 are coaxially aligned, and then externally threaded portion 503a of shaft 501 is threaded into second recess 384 of plug 380 with hexagonal prismatic surface 516 of sleeve 510 seated in mating outer portion 199 of passage 192 of bonnet 190. As shaft 501 can rotate relative to sleeve 510, shaft 501 can be rotated relative to plug 380, bonnet 190, and sleeve 510 to thread externally threaded portion 503a of shaft 501 is threaded into second recess 384 of plug 380 while sleeve 510 remains stationary relative to plug 380 and bonnet 190. Next, tool 500 is used to position and orient plug 380 and bonnet 190 coupled thereto such that axes 195, 385, 505, 515 are coaxially aligned with central axis 325 of access port 320 and then tool 500 is used to insert plug 380 and bonnet 190 into access port 320 while sleeve 510 is rotated about axes 195, 385, 505, 515 with hexagonal prismatic surface 516 of sleeve 510 positively engaging outer portion 199 of passage 192 of bonnet 190 to rotate bonnet 190 relative to plug 380 and housing 310, and thereby thread bonnet 190 into outer portion 324 of access port 320 via mating threads 327, 194 as previously described. As bonnet 190 is threaded into access port 320, plug 380 is axially advanced into intermediate portion 326 of access port 320. Tool 500 is used to thread bonnet 190 into access portion 320 until plug 380 is fully seated and compressed against second annular shoulder 322b and upper surfaces 370c of hinge blocks 370.

During operations, check valve 300 functions in a similar manner as check valve 100. Specifically, check valve 300 may transition between an open position with flapper 361 rotated away from engagement with strike face 403 and a closed position shown in FIG. 22 with sealing surface 364 engaging strike face 403. In particular when fluid flows through throughbore 3116 of housing 310 from inlet 313 at upstream end 310a to outlet 317 at downstream end 310b, check valve 300 may be transitioned to the open position in which flapper 361 is rotated about axes 255, 365 upward and toward access port 320 to thereby clear the flow path along throughbore 316. First recess 382 of plug 380 may at least partially receive back side 361b of flapper 361 so as to allow flapper 361 to fully rotate about axes 255, 365 to open the flow path in throughbore 316 when valve 300 is in the open position.

Conversely, if the fluid flows along throughbore 316 from outlet 317 to inlet 313, the pressure on back side 361b of flapper 361 will increase above the pressure on front side 361a so that flapper 361 may rotated about axes 255, 365 from the open position to the closed position (FIG. 22). In the closed position, sealing surface 364 of flapper 361 engages strike face 403 to thereby prevent and/or restrict the flow of fluid through valve seat 400 to upstream end 310a.

The embodiments disclosed herein include check valves and related assemblies that may provide an enhanced functionality and performance when compared with conventional designs. In some embodiments, a check valve may include one or more features that reduce wear so as to effectively increase a service life of the check valve or components thereof. In addition, in some embodiments, a check valve may include one or more features that facilitate proper installation, maintenance, and customization in the field by on-site technicians so that failures and stoppages due to improper check valve installation or configuration may be reduced or even entirely prevented. Thus, through use of the embodiments disclosed herein, a check valve may enjoy an improved reliability and functionality. The preceding discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A check valve, comprising:
a housing having an upstream end and a downstream end, wherein the housing includes:
a throughbore extending from the upstream end to the downstream end;
an outer surface extending from the upstream end to the downstream end; and
an access port extending from the outer surface to the throughbore, wherein the access port includes an internal annular shoulder and one or more recesses extending into the internal annular shoulder; and
a valve seat disposed in the throughbore of the housing;
a check valve assembly at least partially disposed in the access port, wherein the check valve assembly includes:
a flapper extending into the throughbore and configured to pivot relative to the valve seat between an open position spaced apart from the valve seat and a closed position engaging the valve seat;
one or more flapper alignment members pivotally coupled to the flapper, wherein each flapper alignment member is slidingly seated in one of the recesses in the internal annular shoulder of the access port to align the flapper with the valve seat in the throughbore.

2. The check valve of claim 1, wherein the check valve assembly further comprises an alignment ring including the one or more flapper alignment members, wherein the flapper is pivotally coupled to the alignment ring.

3. The check valve of claim 2, wherein the alignment ring includes an outer annular shoulder, and wherein each flapper alignment member is a key extending from the outer annular shoulder.

4. The check valve of claim 3, wherein the access port has a central axis, and wherein the each key extends axially from the outer annular shoulder of the alignment ring into one of the recesses.

5. The check valve of claim 2, wherein each flapper alignment member is integrally formed with the outer annular shoulder.

6. The check valve of claim 1, wherein the one or more flapper alignment members are configured to be received into the one or more recesses in a single rotational orientation about a central axis of the access port.

7. The check valve of claim 1, wherein the check valve assembly includes a pair of hinge blocks and a pin coupled to the flapper, wherein the pin extends into a receptacle in each hinge block.

8. The check valve of claim 7, wherein the check valve assembly further includes:
a pair of bushings, wherein each of the pair of bushings includes a flange that defines an outer annular shoulder, wherein each bushing of the pair of bushings is disposed in a corresponding one of receptacles of the hinge blocks with the outer annular shoulder of each of the pair of bushings engaging an inner annular shoulder disposed along the corresponding one of the receptacles; and
wherein the pin extends into each of the pair of bushings.

9. The check valve of claim 8, wherein the flapper is coupled to the pin with a pair of hinge ears, and wherein the flange of each of the pair of bushings is positioned between the internal annular shoulder of the corresponding one of the receptacles and a corresponding one of the hinge ears.

10. The check valve of claim 7, wherein each flapper alignment members is one of the hinge blocks.

11. The check valve of claim 1, wherein the flapper has a first side configured to engage the valve seat in the throughbore of the housing, a second side opposite the first side, and a weight removably coupled to and positioned along the second side.

12. The check valve of claim 1, wherein the valve seat is threadably secured in the throughbore.

13. The check valve of claim 1, wherein the valve seat is configured to be slidably inserted axially into the throughbore at the upstream end of the housing.

14. The check valve of claim 1, wherein the housing has a central axis and the throughbore extends axially through the housing from the upstream end to the downstream end, and wherein the access port has a central axis oriented perpendicular to the central axis of the throughbore.

15. A method of assembling a check valve, the method comprising:
(a) inserting a check valve assembly in an access port of a housing of the check valve, wherein the access port has an internal annular shoulder including one or more recesses formed therein, wherein the check valve assembly includes:
a flapper;
one or more flapper alignment members pivotally coupled to the flapper; and
(b) rotating the check valve assembly about a central axis of the access port during or after (a) to insert the one or more flapper alignment members into the one or more recesses and align the flapper relative to a valve seat positioned in a throughbore of the housing.

16. The method of claim 15, wherein the check valve assembly comprises an alignment ring including a pair of hinge blocks, wherein the flapper is pivotally coupled to the hinge blocks and each flapper alignment member is a key extending from the alignment ring;
wherein (b) comprises rotating the alignment ring about the central axis of the access port and axially inserting the one or more keys into the one or more recesses.

17. The method of claim 16, further comprising seating the alignment ring against the internal annular shoulder of the access port while inserting each key into one of the recesses.

18. The method of claim 16, wherein the flapper has a first side configured to engage the valve seat and a second side opposite the first side, and wherein the method further comprises:
(c) removably mounting a weight on the second side of the flapper.

19. The method of claim 18, wherein (c) comprises positioning the weight on the second side of the flapper without removing the flapper and the alignment ring from the housing.

20. The method of claim 15, wherein the check valve assembly includes a pair of hinge blocks and a pin coupled to the flapper, wherein the pin extends into a receptacle in each hinge block.

21. The method of claim 20, wherein the check valve assembly further includes:
a pair of bushings, wherein each of the pair of bushings includes a flange that defines an outer annular shoulder, wherein each bushing of the pair of bushings is disposed in a corresponding one of receptacles of the hinge blocks with the outer annular shoulder of each of the pair of bushings engaging an inner annular shoulder disposed along the corresponding one of the receptacles; and
wherein the pin extends into each of the pair of bushings.

22. The method of claim 21, wherein the flapper is coupled to the pin with a pair of hinge ears, and wherein the flange of each of the pair of bushings is positioned between the internal annular shoulder of the corresponding one of the receptacles and a corresponding one of the hinge ears.

23. The method of claim 20, wherein each flapper alignment members is one of the hinge blocks and (b) comprises inserting each hinge block into one of the recesses.

24. The method of claim 15, further comprising inserting the valve seat into an inlet of the throughbore positioned at an upstream end of the housing.

25. The method of claim 15, further comprising:
(c) inserting a plug into the access port after (a) and (b) to prevent fluid flow through the access port; and
(d) securing a bonnet to the housing in the access port against the plug to maintain the plug in the access port.

26. The method of claim 25, wherein (d) comprises threading the bonnet into the access port during (c).

27. The method of claim 26, further comprising:
(e) extending a shaft of a tool through a through passage of the bonnet before (c) and (d);
(f) threading an end of the shaft of the tool into a recess in the plug after (e) and before (c) and (d);
(g) inserting an end of a sleeve of the tool into the through passage of the bonnet during (f) and before (c) and (d), wherein the sleeve is rotatably disposed about the shaft.

28. The method of claim 27, wherein (c) comprises inserting the plug into the access port with the tool, and (d) comprises rotating the bonnet with the sleeve of the tool during (c) to thread the bonnet into the access port.
